(19) United States
(12) Patent Application Publication
(10) Pub. No.: US 2014/0297382 A1
(43) Pub. Date: Oct. 2, 2014

(54) Electronic Incentive Redemption and Clearing System

(71) Applicant: Beeonics, Inc., Waltham, MA (US)

(72) Inventors: Fabio M. Chiussi, Long Branch, NJ (US); Parameshwar Hegde, Westford, MA (US)

(73) Assignee: Beeonics, Inc., Waltham, MA (US)

(21) Appl. No.: 13/965,129

(22) Filed: Aug. 12, 2013

Related U.S. Application Data
(60) Provisional application No. 61/806,858, filed on Mar. 30, 2013.

(51) Int. Cl. G06Q 30/02

(52) U.S. Cl. CPC G06Q 30/0225
USPC 705/14.26

(57) ABSTRACT

A System Solution offers a Retailer and a Manufacturer a way to prevent Coupon Fraud when Electronic Coupons are used. A plurality of Electronic Coupons are redeemed by Consumers and an Electronic Coupon Clearing Process validates that the redeemed Electronic Coupons are legitimately redeemed by a Consumer when purchasing associated products or services and that the total number and Face Value of the redeemed Electronic Coupons are not altered by any business entity, organization, or individual. The System Solution computes a Redemption Encrypted Identifier that is associated with the redeemed Electronic Coupon and is validated against stored parameters by an Electronic Clearing House. The Redemption Encrypted Identifier is computed using a first identifier known by a Retailer and a second identifier known by a Manufacturer.

### BACKGROUND OF THE INVENTION

Manufacturers, retailers, vendors, and other businesses use incentives to promote their products and services and increase the likelihood that Consumers buy those products and services. For example, incentives may be in the form of discounts which lower the price of a product or a service by a certain percentage (e.g., 10% off the original price). Alternatively, an incentive may allow to purchase a product for a price lower than the original price (e.g., $4.99 for an item that usually costs $5.99), or an incentive may offer certain advantages to the Consumer if he/she purchases a certain product or service (e.g., buy one item, get a second item free). Incentives offer the Consumer the ability to purchase a product or a service in a store or online under more favorable conditions than what is “usually” available.

Incentives are presented to the Consumer as Coupons or Offers. A Coupon is typically associated to one or more products or services. Coupons can also be associated to groups of products or services or apply as discount to a generic purchase (e.g., “10% off anything in the store,” or “$1 off any Appetizer,” or “$5 off on any purchase above $50”). A Coupon contains an offer of a certain Face Value. For example, a “$10 off” Coupon contains an offer of Face Value equal to $10. In another example, a “10% off” Coupon associated to an item with a price equal to $10 contains an offer of Face Value equal to $1. In another example, the Face Value of a “Buy 1 get 1 free” Coupon associated with a product with a price equal to $10 is $10. The term Face Value of the Coupon refers to the difference in price between what a Consumer would have paid to purchase a product or a service without the Coupon, and what that Consumer pays with the Coupon to purchase those same products or services.

Coupons typically have an expiration date. A Consumer receives the discount or advantage associated with the Coupon if he/she purchases the corresponding product or service and presents the Coupon to the vendor before the expiration date. Once the expiration date is reached, the Coupon is said to have “expired” and the associated discount or advantage is not given to the Consumer when he/she purchases the product or service. For example, a “$1 off” Coupon associated to a product of price equal to $10 with an expiration date of Mar. 10, 2013 would allow a Consumer to purchase the product for $9 only on or before Mar. 10, 2013. The term “Using a Coupon” refers to a Consumer purchasing a product or a service, presenting a non-expired Coupon to the retailer, vendor, or business selling the product, and receiving the Face Value of the coupon.

Coupons may also contain certain terms and conditions to restrict or further specify when a Consumer can use them. For example, a Coupon with a condition “Valid only on weekends” can only be used by a Consumer to receive the corresponding discount or advantage if the purchase is made on a Saturday or on a Sunday. Another example of a term and condition includes a Coupon containing the condition “Offer cannot be combined with any other offers.” In this case, a Consumer purchasing a certain product associated with more than one Coupon can only use one of those Coupon in association with his/her purchase. A limit may also be placed on the total number of instances of a certain Coupon that may be used by Consumers. For example, a Coupon may be used “for the first 3,000 purchases.” Once the limit is reached, the Coupon may not be used anymore.

The use of Coupons to promote products and services is very common. For example, in the US alone, billions of Coupons are printed and redeemed every year. The Coupon industry is a multi-billion dollar industry involving manufacturers, retailers, publishers, clearing houses, and other businesses. The use of Coupons by Consumers is very widespread. Coupons “save money” to a Consumer when used in association with a purchase in the sense that the Consumer either pays a lower price for the product or receives some advantage (for example, gets more of the product for a given price) by using the Coupon.

We use the terms Incentive, Coupon, and Offer interchangeably to refer to means that manufacturers, retailers, vendors, and other businesses use to make the price of a product or a service more attractive to a Consumer so he/she is more likely to buy that product or service. This may be achieved by using Incentives, Coupons, and Offers that may lower the price of a product or service, provide a discount, increase the quantity of the product or service that can be purchased for a certain price, or provide some other advantages associated with the purchase.

Since Coupons have a Face Value that provides some kind of “monetary” advantage or some other concrete benefit to a Consumer who uses the Coupon in association with a purchase, Coupons typically must be “redeemed” at the time of purchase in order to be used and in order for the Consumer to receive the associated discount or advantage. The term “Redeeming a Coupon” refers to the Manufacturer, Retailer, Vendor, or business performing a Redemption Process that verifies that the Coupon is valid and can be used by the Consumer to receive the associated discount or advantage. The Redemption Process includes the following; validating that the Expiration Date has not yet passed; validating that the other terms and conditions are met; validating that the Coupon is “legitimate.” A legitimate Coupon is a Coupon that has been generated by the associated Manufacturer, Retailer, Vendor, or business, and has not been fraudulently generated by somebody else (e.g., the Consumer) in an attempt to purchase the associated product or service under more favorable conditions or with the intent of committing Coupon Fraud. A legitimate Coupon has been obtained by a Consumer in a “legitimate” way. For example, a Consumer may have clipped the Coupon out of a newspaper or magazine where that Coupon was published, or may have received the Coupon in the mail. Non-legitimate ways in which Coupons may be obtained by a Consumer include using a color copy machine to fraudulently creating multiple copies of a single Coupon that the Consumer has received in the mail. Depending on each specific Coupon, the associated Manufacturer, Retailer, Vendor, or business may want to control the total number of Coupon instances that are distributed to Consumer, and thus the practice of duplicating a Coupon by a Consumer in an unauthorized fashion may be considered a form of Coupon Fraud. The Redemption Process may also be used by the Manufacturer, Retailer, Vendor, or business to count the number of Coupons that are used and record their Face Value and associated product or service, for bookkeeping and accounting purposes.

The Redemption Process may be manual, automated, or a combination of manual and automated. For example, the operator of the Cash Register may visually inspect a printed Coupon to check for Expiration Date and terms and conditions. In order to make the Redemption Process more automated, a Coupon may include a Bar Code which encodes a unique identifier identifying the Coupon and its Face Value, Expiration Date, and terms and condition. When the Consumer wants to use the Coupon at a store, the Bar Code is scanned by a scanner device capable of reading and decoding the Bar Code. The scanner device may be placed next to the Cash Register or Point of Sale (PoS) system at the store, so that when a Consumer purchases a product or service and wants to use an associated Coupon, the operator of the PoS scans the Coupon and performs the Redemption Process. If the Redemption Process validates the Coupon, the Consumer receives the discount or advantage associated with the Coupon.

There are many types of incentives, Coupons, and offers. A first type of Coupons is referred to as Retailer Coupons. A Retailer Coupon is generated by a business entity that sells products or services directly to a Consumer via a physical store or an online store. Examples of such a business entity include a Retailer or a Vendor owning one or more physical or online stores. The Retailer generates Retailer Coupons for corresponding products or services by directly setting a Face Value related to the price of those products or services as they are sold in the Retailer's store. When a Consumer uses a Coupon with a certain Face Value to purchase a product or a service, the profit that the Retailer makes from that purchase is lowered by the amount of the Face Value with respect to the profit that the Retailer would have made if the Consumer had bought the same product or service without using the Coupon. The business justification for the Retailer to use the incentive is that, although the profit that the Retailer makes from an individual purchase when a corresponding Coupon is used is lower than the profit of that same purchase when a Coupon is not used, the Consumers will make more purchases because the corresponding Coupon makes the product or service more likely to be purchased, so the total profit from all the purchases using Coupons may be higher than the total profit from all the purchases if Coupons had not be used. However, since each redeemed Coupon represents a potential loss in profit for the Retailer, the Retailer may want to control the total number of Coupons that are distributed, since the effectiveness of the incentive is eventually reduced if too many Coupons are circulated.

A second type of Coupon is referred to as Manufacturer Coupons. A Manufacturer is a first business entity that builds products or services and sells its products to a Consumer using a physical or online store belonging to a second business entity. This second business entity may be a Retailer or a Vendor. The Manufacturer generates Manufacturer Coupons for its products or services by setting a Face Value related to the price of those products or services as they are sold in the Retailer's store. The Face Value of the Manufacturer Coupons reduces the profit that the Retailer makes from the Consumers purchasing the corresponding products or services. To compensate for this loss of profits, the Manufacturer reimburses the Retailer for the Face Value of all the Manufacturer Coupons redeemed by Consumers in the Retailer's store. The Manufacturer may reimburse the Retailer for the entire Face Value or for a pre-negotiated portion of the Face Value of all the Manufacturer Coupons redeemed by Consumers in the Retailer's store. When a Consumer uses a Manufacturer Coupon for a purchase at the Retailer's store, the Retailer does not lose profit from the associated purchase since the loss in profit associated with the Coupon's Face Value is reimbursed, in its entirety or at least in part, by the Manufacturer. An example of this arrangement may include Procter & Gamble™, which produces Tide™ detergent, which is sold at Walmart™ stores. Procter & Gamble™ may generate a Manufacturer Coupon associated to a 1-Gallon Tide™ detergent sold at Walmart™ containing an offer giving a $2 discount until a certain Expiration Date. Procter & Gamble™ provides the Manufacturer Coupon to Walmart™ which distributes it to its customers. In this example, 3,000 Consumers purchase the 1-Gallon Tide™ at Walmart™ and use the corresponding Manufacturer Coupon before the Expiration Date. The total Face Value of all the used Manufacturer Coupons is $6,000. Procter & Gamble™ reimburses Walmart™ for such an amount. Since the amount of the reimbursement that the Manufacturer has to give to the Retailer is proportional to the number of legitimately redeemed Coupons, which in turn is proportional to the total number of Coupons that are distributed to the Consumers, the Manufacturer may want to keep control on the total number of Coupons that are distributed. For this reason, the practice of duplicating Coupons in an unauthorized fashion may be considered a form of Coupon Fraud.

A third type of Coupon is a Franchise Coupon. A Franchise is a business entity that owns a Corporate Brand which sells products or services. The products or services are sold to Consumers using physical or online stores that are owned by Franchisees. The Franchisees are independent business entities from the Franchise in that they own and run one or more stores, but sell products or services in those stores that carry the Corporate Brand. The Franchisees profit from selling Corporate Brand products or services and typically pay certain fees to the Franchise for the right of using the Corporate Brand. The Franchisees typically have certain obligations on how the Corporate Brand products are sold. An example of such an arrangement may include Panera Bread™. The Panera Bread Franchise owns the Panera Bread Corporate Brand. The Franchisees own the individual stores and pay certain fees to the Panera Bread Franchise to use the Panera Bread Corporate Brand. The Franchisees also have other obligations, including allowing the Panera Bread Franchise to set the price of the sesame bagels sold in their store. The Franchise may generate a Franchise Coupon giving a certain discount or advantage corresponding to a certain product or service purchased in a Franchisee store. The Franchise may reimburse the Franchisees for the Face Value of the Franchise Coupons, in their entirety or in part, redeemed in the Franchisees' stores. Franchise Coupons are similar to Manufacturer Coupon, with the Franchise acting as the Manufacturer and the Franchisees acting as the Retailers. Because of this similarity, the term “Manufacturer Coupon” is meant to refer to “Franchise Coupon” as well.

Coupons are generated by Manufacturers, Retailers, Franchises, vendors, and other businesses by determining the associated products or services, the Face Value, the Expiration Date, the terms and conditions, and the limit on the total number of Coupons that may be used. Once they are generated, the Coupons are published, so a large number of printed instances of that Coupon is created and distributed to the Consumers. For this purpose, Coupons may be attractively designed and published on printed media, such as newspapers and magazines, printed and mailed directly to Consumers, displayed online on websites, or distributed via other means. Once Consumers are made aware of the existence of the published Coupons, they may select those Coupons that correspond to products or services that they desire to purchase. Consumers may then get a physical instance of the selected Coupons so they can carry them to the store and use them when making a corresponding purchase. This step may involve the Consumer clipping a Coupon out of a magazine or a flier, or printing a Coupon displayed on a website. The term Coupon also refers to all the physical and online instances of a Coupon that has been published so it can be used by Consumers.

Since the Coupons have a Face Value that represents a “real” monetary value or concrete advantage for Consumers, Retailers, Manufacturers, Franchises, or other Businesses using incentives, means have to be provided to prevent Coupon Fraud. Any entity or individual involved in the life cycle of Coupons which may obtain a financial advantage by generating or manipulating Coupons in unauthorized ways is a potential candidate to commit Coupon Fraud; thus, Coupon Fraud is a threat that must be combatted. For example, Consumers may commit Consumer Coupon Fraud. A Consumer may generate “false” Coupons with offers that are not authorized by a Retailer, in an attempt to purchase a product or service at a lower price. Also, Consumers may duplicate a single Coupon instance that they clipped from a magazine or received in the mail to generate multiple unauthorized copies of that Coupon in order to benefit from the associated discount or advantage multiple times instead of only once. The operator of a Point of Sale may commit PoS Operator Coupon Fraud. In this case, a Cashier at a store may print many copies of a Coupon and substitute those Coupons in the cash register by pocketing each time an amount of cash equal to the Face Value.

A very insidious type of Coupon Fraud is Retailer Coupon Fraud in the case of Manufacturer Coupons. Since the Manufacturer reimburses the Retailer for the Face Value of all the Manufacturer Coupons redeemed at the Retailer's stores, the Retailer may inflate the number of Coupons that were redeemed, so the Manufacturer reimburses the Retailer for a sum that is higher than the profit lost by the Retailer because of the use of the Coupons. In order to avoid this type of Coupon Fraud, a Coupon Clearing Process is performed to make sure that the Redeemed Coupons are legitimate Coupons, that the number of Redeemed Coupons and their Face Value is not altered by the Retailer, and that the Manufacturer reimburses the Retailer for the correct amount of profit lost due to the use of Manufacturer Coupons. The Coupon Clearing Process significantly reduces Coupon Fraud, but it does not guarantee eliminating Coupon Fraud. Like any other system, the Coupon lifecycle can always be potentially attacked and beaten by malicious behavior. However, the Coupon Clearing Process makes it considerably more difficult for any individual or entity involved in the Coupon lifecycle to commit Coupon Fraud.

In all cases, Coupon Fraud is more difficult to occur if the physical instances of the Coupons have to be presented at the store at the time the associated purchase is made. For this reason, the Coupon industry has been largely based on requiring physical instances of Coupons throughout the life cycle of the Coupon, from generation of the Coupons, to the publishing of the physical instances, to the clipping or printing of the physical instances of the Coupons by Consumer, to the presentation of those physical instances to the Retailer at the time of purchase, to the storage of those physical instances of the redeemed Coupons by the Retailer, to the counting of the physical instances of the redeemed Coupons so their Face Value can be correctly computed.

FIG. 1 shows a Manufacturer 1-1 building a plurality of Products 1-15 comprising Product 1 1-16, Product 2 1-17, to Product N 1-18. The Manufacturer 1-1 associates a plurality of Manufacturer Coupons 1-4 comprising Manufacturer Coupon 1 1-5, Manufacturer Coupon 2 1-6, to Manufacturer Coupon N 1-7. For example, a Manufacturer Coupon 1 1-5 is associated with Product 1 1-16, a Manufacturer Coupon 2 1-6 is associated with Product 2 1-17, and a Manufacturer Coupon N 1-7 is associated with Product N 1-18. In this case, a Manufacturer Coupon 1 1-5 may offer a discount on the price of a Product 1 1-16.

A Retailer 1-2 owns a plurality of Stores 1-8 comprising Store 1 1-9, Store 2 1-10, to Store N 1-11. The Retailer 1-2 sells goods, products, or services to Consumer 1-3 using the plurality of Stores 1-8. Each Store in the plurality of Stores 1-8 contains a Point of Sale (PoS) through which the Consumer 1-3 pays for the goods, products, or services that he/she purchases at that Store. For instance, a Store 1 1-9 contains a Point of Sale 1 1-12, a Store 2 1-10 contains a Point of Sale 2 1-13, and a Store N 1-11 contains a Point of Sale N 1-14. Each Point of Sale may comprise a Cash Register and a Credit Card Reader through which the Consumer can pay for his/her purchase. Each Point of Sale may also comprise a Bar Code Scanner capable of scanning a Bar Code of a Coupon and other equipment capable of performing the Redemption Process for a Coupon, so a Consumer can present a physical instance of a Coupon, redeem it, and receive a corresponding discount or advantage on a purchase. The Point of Sale may also comprise a storage drawer, storage bag, or other storage equipment where the operator of the Point of Sale can store the physical instances of the Coupons that are redeemed. The Point of Sale may also comprise other equipment to allow payment, Coupon Redemption, and Coupon storage.

The Retailer 1-2 sells the plurality of Products 1-15 of Manufacturer 1-1 in its plurality of stores 1-8. The Retailer 1-2 may also sell other products or services that are not built by Manufacturer 1-1. The Manufacturer 1-1 creates the plurality of Manufacturer Coupons 1-4 associated with its plurality of Products 1-15 and provides these Coupons to the Retailer 1-2.

FIG. 2 illustrates the process that the Retailer 1-1 uses to publish and distribute Coupons to the Consumer 1-3. The Retailer 1-1 has the plurality of Manufacturer Coupons 1-4 comprising Manufacturer Coupon 1 1-5, Manufacturer Coupon 2 1-6, to Manufacturer Coupon N 1-7. The Retailer may also have a plurality of Retailer Coupons 2-1 comprising Retailer Coupon 1 2-2, Retailer Coupon 2 2-3, to Retailer Coupon N 2-4. The Retailer publishes the plurality of Manufacturer Coupons 1-4 and the plurality of Retailer Coupons 2-1 on Printed Media 2-5 and creates a large number of printed physical instances that are distributed to a plurality of Consumers. A plurality of Printed Coupon 2-6 comprises Printed Coupon 1 2-7, Printed Coupon 2 2-8 to Printed Coupon N 2-9. Examples of Printed Media 2-5 include a Coupon published on a Newspaper or a Magazine, a printed Coupon sent to a Consumer 1-3 via Direct Mail, a Coupon published on a Flier that is mailed to a Consumer 1-3 or is distributed at a store, a Coupon made part of a Coupon envelope that is mailed to a Consumer 1-3, a Coupon made part of a Coupon book that is mailed to a Consumer 1-3, a printed Coupon that is handed to a Consumer 1-3 at a store or at a Point of Sales contained in a store, a Coupon that is selected and printed by a Consumer 1-3 from a kiosk located in a store, a Coupon displayed on an online website and printed by a Consumer 1-3 on a printer and carried by the Consumer 1-3 to a store.

The Consumer 1-3 in “Consumer Selects Coupons” 2-10 selects the Printed Coupons in the plurality of Printed Coupons 2-6 that he/she desires to use. In “Consumer Clips Coupons” 2-11, the Consumer 1-3 physically clips or prints the desired Printed Coupons so the physical instances of those Printed Coupons become the Consumer's possession and the Consume can carry those physical instances of the Printed Coupons to the Store. The plurality of Consumer's Printed Coupon 2-12, comprising Consumer's Printed Coupon 1 2-13, Consumer's Printed Coupon 2 2-14, to Consumer's Printed Coupon N 2-15, represents the clipped or printed physical instances of Printed Coupons that Consumer 1-3 brings to a Store of a Retailer 1-2.

FIG. 3 illustrates the process through which a Consumer 1-3 uses a Coupon in the plurality of Coupons 2-12. The Consumer 1-3 brings the plurality of Consumer's Printed Coupons 2-12 to a Store 3-4, containing a Point of Sale (PoS). The Store 3-4 sells at least one product or service associated to at least one of the Consumer's Printed Coupons in the plurality of Consumer's Printed Coupons 2-12. Each Consumer's Printed Coupon in the plurality of Consumer's Printed Coupons 2-12 is associated with one or more products or services and has a corresponding Coupon Face Value. For example, a Consumer's Printed Coupon 1 2-13 has a Coupon Face Value 1 3-1, a Consumer's Printed Coupon 2 2-14 has a Coupon Face Value 2 3-2 and a Consumer's Printed Coupon N 2-15 has a Coupon Face Value N 3-3.

A Consumer 1-3 goes to a Store 3-4 that contains a Point of Sale (PoS) 3-5 to purchase a certain product for which the Consumer has a corresponding Consumer's Printed Coupon. “Consumer Goes to Store” 3-6 and “Consumer Buys Product N” 3-7. The Consumer 1-3 has a Consumer's Printed Coupon N 2-15 in the plurality of Consumer's Printed Coupons 2-12 that is associated with the Product N that the Consumer desires to purchase. When the Consumer gets to the Point of Sale (PoS) 3-5 to pay for the Product N, the “Consumer Redeems Printed Coupon N” 3-7. The Redemption Process is performed in order to validate the Coupon. The “Consumer gives Consumer's Printed Coupon N to Store PoS” 3-9. For example, the Consumer 1-3 hands the Consumer's Printed Coupon N 2-15 to the operator of the Point of Sale (PoS) 3-5 who uses a scanner to scan a Bar Code printed on Consumer's Printed Coupon N 2-15. If the Redemption Process validates Consumer's Printed Coupon N 2-15, the Consumer's Printed Coupon N 2-15 is the Redeemed Printed Coupon N 3-10 and the “Consumer Receives Coupon Face Value N Discount” 3-8. For example, the Consumer receives a discount on the price of the product associated with Consumer's Printed Coupon N 2-15 equal to Coupon Face Value N 3-3. The “Store Keeps Redeemed Printed Coupon N” 3-11. For example, the operator of the Point of Sale (PoS) 3-5 stores the physical instance of the Redeemed Printed Coupon N 3-10 in a storage drawer comprised in the Point of Sale (PoS) 3-5.

In the case the Redeemed Printed Coupon N 3-10 is a Manufacturer's Coupon for a Manufacturer 1-1, at regular intervals, the Coupon Clearing Process is executed to count all the Redeemed Printed Coupons that have been redeemed at a store for Manufacturer 1-1 during a certain period of time, for example during a month. The Coupon Clearing Process “assures” that the number of Redeemed Printed Coupons corresponds to the number of Redeemed Printed Coupons that have been actually redeemed by Consumers when those Consumers purchased the corresponding products of services of Manufacturer 1-1. The Coupon Clearing Process prevents Retailer Coupon Fraud. More precisely, the Coupon Clearing Process makes it significantly more difficult for the Retailer or Manufacturer to commit Coupon Fraud, but does not guarantee to eliminate Coupon Fraud, since malicious behavior may find a way to circumvent the Coupon Clearing Process. The Coupon Clearing Process may comprise one or more Clearing Houses which are business entities independent from the Retailer 1-2 and the Manufacturer 1-1 in charge of counting the Redeemed Coupons. The Coupon Clearing Process is based on having a plurality of independent business entities independently counting and validating the physical instances of Redeemed Coupons for Manufacturer 1-1 and comparing the totals to assure that the Redeemed Coupons are legitimate Coupons that Consumers have redeemed at the Store. In certain cases, the business entities may not be independent, and the independent counting is performed by a plurality of independent organization within one or more independent business entities. The basic principle is that the counting is performed by a plurality of entities, individuals, or organizations that are trusted not to be communicating and not to be in collusion with one another, so the plurality of totals is considered by the Retailer 1-2 and the Manufacturer 1-1 to be independently computed. The reason why one or more independent Clearing Houses are often used as part of the Coupon Clearing Process is that the Retailer 1-2 and the Manufacturer 1-1 may not trust each other to perform a correct count. In fact, the Retailer 1-2 has an interest in inflating the count in order to receive a reimbursement from the Manufacturer 1-1 higher than the loss of profit associated with the Redeemed Coupons, and the Manufacturer 1-1 has an interest in lowering the count in order to provide a reimbursement lower than the actual loss of profit associated with the Redeemed Coupons. The reason why this issue is so important in the Coupon industry is that in the US alone, the total reimbursements amount to billions of dollars per year. A person skilled in the art would recognize variations of the Coupon Clearing Process that are within the spirit of the Coupon Clearing Process described herein.

FIG. 4 illustrates the Coupon Clearing Process that is followed by both the Retailer and Manufacturer to agree on the number and face value of the Redeemed Printed Coupons. The Retailer 1-2 has stored a plurality of Redeemed Printed Coupons 4-1 comprising Redeemed Printed Coupon 1 4-2, Redeemed Printed Coupon 2 4-2, to Redeemed Printed Coupon N 4-4. The Redeemed Printed Coupons in the plurality of Redeemed Printed Coupons 4-1 are Manutacturer Coupons associated with products of Manufacturer 1-1. The Retailer 1-2 has collected and stored these Redeemed Printed Coupons from Consumers who have redeemed these Coupons as they purchased the associated products or services and received the associated discounts or advantages. The Manufacturer 1-1 reimburses the Retailer 1-2 for the total Face Value of all the Redeemed Printed Coupons that have been redeemed by Consumers as they purchased the associated products or services. The Coupon Clearing Process validates that the Redeemed Printed Coupons in the plurality of Redeemed Printed Coupons 4-1 are “legitimate” Coupons, i.e., they are physical instances of Printed Coupons that were clipped or printed by Consumers in an authorized fashion and carried to the store. The Coupon Clearing Process provides the correct count of the number of Coupons in the plurality of legitimately Redeemed Printed Coupons 4-1. The Coupon Clearing Process may also provide the total Face Value of the Coupons in the plurality of Redeemed Printed Coupons 4-1.

The “Retailer Counts Redeemed Printed Coupons” 4-5 in the plurality of Redeemed Printed Coupons 4-1. The Retailer 1-2 may also compute the total Face Value of the Coupons in the plurality of Redeemed Printed Coupons 4-1. The Retailer stores this total as the Retailer Redeemed Printed Coupons Count and the Retailer Redeemed Printed Coupons Total Face Value. Then the “Retailer Sends Redeemed Printed Coupons to Clearing House 1” 4-6. In this step, the physical instances of the Redeemed Printed Coupons are sent to a Clearing House 1 4-7.

The “Clearing House 1 Counts Redeemed Printed Coupons” 4-8. In this step, the Clearing House 1 4-7 validates that the Redeemed Printed Coupons in the plurality of Redeemed Printed Coupons 4-1 that were sent by the Retailer 1-2 are “legitimate” Coupons, and counts the Redeemed Printed Coupons in the plurality of Redeemed Printed Coupons 4-1. The Clearing House 1 4-7 may also compute the total Face Value of the Coupons in the plurality of Redeemed Printed Coupons 4-1. The “Clearing House 1 Sends Redeemed Printed Coupons Count to Manufacturer” 4-9. In this step, the Clearing House 1 4-7 may also send the computed Total Face Value of the Coupons in the plurality of Redeemed Printed Coupons 4-1 to the Manufacturer 1-1.

“Clearing House 1 Sends Redeemed Printed Coupons to Clearing House 2” 4-10. This step is performed if the Retailer 1-2 or the Manufacturer 1-1 desires more than one Clearing House to count the Redeemed Coupons. In this case, the Redeemed Printed Coupons are sent to Clearing House 2 4-11. The “Clearing House 2 Counts Redeemed Printed Coupons” 4-12. In this step, the Clearing House 2 4-11 validates that the Redeemed Printed Coupons in the plurality of Redeemed Printed Coupons 4-1 that were sent by the Retailer 1-2 are “legitimate” Coupons, and counts the Redeemed Printed Coupons in the plurality of Redeemed Printed Coupons 4-1. The Clearing House 2 4-11 may also compute the total Face Value of the Coupons in the plurality of Redeemed Printed Coupons 4-1. The “Clearing House 2 Sends Redeemed Printed Coupons Count to Manufacturer” 4-13. In this step, the Clearing House 2 4-11 may also send the computed Total Face Value of the Coupons in the plurality of Redeemed Printed Coupons 4-1 to the Manufacturer 1-1.

The Manufacturer 1-1 compares the Redeemed Printed Coupons Count sent by all the Clearing Houses and the Total Face Value computed by all the Clearing Houses. The Manufacturer 1-1 may also receive the physical instances of the plurality of Redeemed Printed Coupons 4-1 so the Manufacturer 1-1 can also count them, verify that they are legitimate, and compute the Total Face Value. The Manufacturer 1-1 determines the Redeemed Printed Coupons Count and the Total Face Value of the Counted Redeemed Coupons. The “Manufacturer Reimburses Retailer for Face Value of Counted Redeemed Coupons” 4-14. In certain cases, the Manufacturer 1-1 reimburses the Retailer 1-2 for only a pre-negotiated portion of the Total Face Value of the Counted Redeemed Coupons. The Retailer 1-2 compares the reimbursement of Face Value of Counted Redeemed Coupons with the stored Retailer Redeemed Printed Coupons Total Face Value. If the reimbursed Face Value (or pre-negotiated portion) matches the stored Retailer Redeemed Printed Coupons Total Face Value, the reimbursement amount is correct, and the Manufacturer 1-1 and Retailer 1-2 conclude the Coupon Clearing Process for the plurality of Redeemed Printed Coupons 4-1.

The described Coupon Clearing Process is based on counting and validating physical instances of Manufacturer's Coupons. The Coupon Clearing Process industry counts and verifies billions of physical instances of Manufacturer's Coupons every year. The Coupon Clearing Process or variations of such process that would be recognized by a person skilled in the art is a commonly accepted and widely used practice in clearing Manufacturer Coupons to prevent Coupon Fraud. Variations of the process are used to prevent Coupon Fraud in the case of Retailer Coupons and Franchise Coupons.

### BRIEF SUMMARY OF THE INVENTION

One of the embodiments of the invention redeems and clears electronically Electronic Coupons. The Consumer carries an Electronic Coupon Instance displayed on a Mobile Device. The Electronic Coupon Instance contains a Bar Code. The Bar Code can also be a QR code or any other form of representation of an electronic code that can be read by a scanner device. The Bar Code encodes a Redemption Encrypted Identifier. The Store contains a PoS which has a Bar Code Scanner capable of reading the Bar Code. The Scanned Bar Code is used by PoS to redeem the Electronic Coupon. Once the Electronic Coupon is redeemed the Consumer Receives the Associated Discount.

Another one of the embodiments of the invention gives the Manufacturer confidence that the instance of the Electronic Coupon has indeed been redeemed by a Consumer in association with a purchase of an associated product and that the number of Redeemed Electronic Coupons have not been fraudulently inflated by the Retailer. The Electronic Coupon Clearing Process also allows the Retailer and Manufacturer to track the instances of Electronic Coupons and the associated Mobile Devices and Consumer that redeem those instances. In case of a dispute on the number of Redeemed Electronic Coupons, the Retailer and Manufacturer can use the data collected as part of the Electronic Redemption Process and Electronic Coupon Clearing Process to support their computations and provide details of which Consumers redeemed which instances at what time and in which stores.

Another one of the embodiments of the invention provides encryption in the Electronic Coupon Clearing Process. The encryption is based on computing and verifying a Redemption Encrypted Identifier. An Encrypted Identifier is computed by the Identifier Encryption Function which uses as inputs a plurality of Identifiers, a Time of Day and Date and a Parameter may also be used as inputs of the Encryption Function. The Identifier Encryption Function uses an Encryption Key to compute a single Encrypted Identifier. A property of the Identifier Encryption Function is that there is an Identifier Decryption Function which computes a plurality of Decrypted Identifiers. It also computes a Decrypted Time of Day and Date, and Decrypted Parameter. Once decrypted, the plurality of Decrypted Identifiers, the Decrypted Time of Day, Date, and the Decrypted Parameter are identical to the plurality of Identifiers, Time of Day, Date, and Parameter that were the inputs of the Identifier Encryption Function.

In another one of the embodiments of the invention, the Identifier Encryption Function may be a “secret,” meaning that not all entities, organizations, or individuals involved in the Electronic Coupon Clearing Process may have knowledge of the Identifier Encryption Function. The Encryption Key, the Identifier Decryption Function, and the Decryption Key may also be a secret and not be known by all entities, organizations, or individuals involved in the Electronic Coupon Clearing Process. By controlling which entities, organizations, or individuals know the Identifier Encryption Function, Encryption Key, Identifier Decryption Function, and Decryption Key, it is possible to control who can encrypt and decrypt the Encrypted Identifier and build a System Solution that offers a Retailer and a Manufacturer an Electronic Coupon Clearing Process that performs the clearing of redeemed Electronic Coupons with a level of secrecy.

In another one of the embodiments of the invention, a variation of the ways the Encrypted Identifier is encrypted and decrypted by a Multi-Key Identifier Encryption Function and a Multi-Key Identifier Decryption Function is described. In this case, multiple Encryption Keys and Decryption Keys are used, each Encryption Key and Decryption Key acting on a subset of the inputs of the Multi-Key Identifier Encryption Function. For example, a first Partial Encryption Key is used in the Multi-Key Identifier Encryption Function on a first Identifier, Time of Day and Date, and Parameter, and a second Partial Encryption Key is used in the Multi-Key Identifier Encryption Function on a second Identifier, Time of Day and Date, and Parameter. Similarly, the Multi-Key Identifier Decryption Function uses a second Partial Decryption Key to compute a first Decrypted Identifier, Decrypted Time of Day and Date, and Decrypted Parameter, and uses a second Partial Decryption Key to compute a second Decrypted Identifier, Decrypted Time of Day and Date, and Decrypted Parameter. These Partial Encryption Keys and Partial Decryption Keys offer further control on which keys are known by which entities, organizations, or individuals involved in the Coupon Clearing Process.

In another one of the embodiments of the invention, a System Solution providing an Electronic Clearing Process. The Retailer has one or more Retailer Server that sends and receives communication to/from the Internet together with Retailer Storage Devices capable of storing and distributing the Electronic Coupons, and capable of storing Consumer Identifiers and Redemption Encrypted Identifiers that are scanned at the Retailer's store. The Retailer Server is also capable of sending Consumer Identifiers and other Identifiers to the Electronic Clearing House Server and receiving Identifiers and other data from the Electronic Clearing House, capable of encrypting and decrypting Encrypted Identifiers using Identifier Encryption Functions, Identifier Decryption Functions, Multi-Key Identifier Encryption Functions and Multi-key Decryption Functions. The Manufacturer has one or more Manufacturer Server that sends and receives communication to/from the Internet together with Manufacturer Storage Devices capable of storing and distributing other information, capable of sending Coupon Instance Identifiers and other Identifiers to the Electronic Clearing House Server and receiving Identifiers and other data from the Electronic Clearing House, capable of encrypting and decrypting Encrypted Identifiers using Identifier Encryption Functions, Identifier Decryption Functions, Multi-Key Identifier Encryption Functions and Multi-key Decryption Functions. The Electronic Clearing House has one or more Servers that sends and receives communication to/from the Internet. The Electronic Clearing House Server is also capable of sending Identifiers to the Retailer Server and Manufacturer Server and of sending Redemption Encrypted Identifiers to a Mobile Device running a Mobile Application or a Web Browser. These Mobile Devices receives the Redemption Encrypted Identifiers from the Internet. The Electronic Clearing House has Electronic Clearing House Computing Devices that may be capable of encrypting and decrypting Encrypted Identifiers. The Consumer has a Mobile Device that sends and receives communication to/from the Internet running a Mobile Application or a Mobile Device running a Web Browser. The Mobile Application and the Web Browser are capable to access the Retailer Server to download Electronic Coupons and to access the Electronic Clearing House Server to download Redemption Encrypted Identifiers and capable of generating Encrypted Identifiers using Identifier Encryption Functions or Multi-Key Identifier Encryption Functions.

In another one of the embodiments of the present invention, the Electronic Coupon Clearing Process consists of two phases: an Identifier Generation and Distribution phase and an Identifier Clearing phase. The Identifier Generation and Distribution phase comprises a Retailer that sends a Consumer Identifier which identifies a Consumer in the plurality of Consumers to an Electronic Clearing House. A Manufacturer sends a Coupon Instance Identifier which identifies a Coupon Instance in the plurality of Coupon Instances to the Electronic Clearing House. The Electronic Clearing House matches the Consumer Identifier with the Coupon Instance Identifier and stores the matching pair of Identifiers for performing validation. The Electronic Clearing House keeps the Encryption Key and Decryption Key of the Redemption Identifier Encryption Function a secret from the Retailer and Manufacturer so they are not able to encrypt and decrypt Redemption Encrypted Identifiers. The generated Redemption Encrypted Identifier is downloaded to the Mobile Device which receives the download from a wireless connectivity corresponding to the Consumer Identifier.

Another one of the embodiments of the invention provides the Identifier Clearing phase. When a Consumer redeems the Electronic Coupon at a Retailer's store, the corresponding Bar Code representing the Redemption Encrypted Identifier is scanned and stored in the Retailer Storage Devices and sent to the Electronic Clearing House to validate that the Electronic Coupon was indeed redeemed by a Consumer at the store in conjunction with a purchase of an associated product. The Time of Day and Date of when the Redemption Encrypted Identifier was scanned and a Parameter such as the location of the Store may also be sent to the Electronic Clearing House as additional data in support that the redemption indeed occurred at that time and in that store. The Electronic Clearing House uses a Redemption Identifier Decryption Function corresponding to the first Redemption Identifier Encryption Function to compute a Coupon Instance Identifier and a Consumer Identifier. If the computed Coupon Instance Identifier and Consumer Identifier match with the pair of identifiers, the Electronic Clearing House declares the redemption a Legitimate Redemption and informs the Manufacturer and Retailer.

Another one of the embodiments of the present invention uses a different way to generate the Redemption Encrypted Identifier that is sent to the Electronic Clearing House to be used in the Identifier Clearing Phase. The Identifier Clearing phase does not generate the Bar Code when the Redemption Encrypted Identifier is downloaded or received by to the Mobile Device. When a Consumer redeems their Electronic Coupon at a Retailer's store, the Mobile Application or Web Browser uses a second Redemption Identifier Encryption Function which uses the Redemption Encrypted Identifier and the Time of Day and Date corresponding to when the Electronic Coupon is ready to be scanned at the PoS at the Store to generate a Time-Based Redemption Encrypted Identifier, and a Bar Code representing the Time-Based Redemption Encrypted Identifier. Now the Bar Code is scanned and the Scanned Time-Based Redemption Encrypted Identifier is sent to the Electronic Clearing House. The Encryption Key is a secret for the Retailer, so the Retailer cannot generate the Time-Based Redemption Encrypted Identifier. The Electronic Clearing House uses a Redemption Identifier Decryption Function corresponding to the second Redemption Identifier Encryption Function to compute the Redemption Encrypted Identifier from the Scanned Time-Based Redemption Encrypted Identifier. Then, the Electronic Clearing House uses a Redemption Identifier Decryption Function corresponding to the first Redemption Identifier Encryption Function to compute a Coupon Instance Identifier and a Consumer Identifier from the Redemption Encrypted Identifier. If the computed Coupon Instance Identifier and Consumer Identifier match with the pair of identifiers, the Electronic Clearing House declares the redemption a Legitimate Redemption and informs the Manufacturer and Retailer.

Another one of the embodiments of the present invention shows an Identifier Generation and Distribution phase included in another one of the embodiments of an Electronic Coupon Clearing Process. The Retailer does not want to disclose the Consumer Identifier to the Electronic Clearing House or the Manufacturer does not want to disclose the Coupon Instance Identifier to the Electronic Clearing House. Then, the Retailer generates and sends an Encrypted Consumer Identifier using an Identifier Encryption Function to the Electronic Clearing House. If the Retailer keeps the Decryption Key of such Encrypted Consumer Identifier secret from the Electronic Clearing House, the Retailer does not need to expose the actual Consumer Identifier to the Electronic Clearing House. Similarly, the Manufacturer generates and sends an Encrypted Coupon Instance Identifier using a different Identifier Encryption Function to the Electronic Clearing House. If the Manufacturer keeps the Decryption Key of such Encrypted Coupon Instance Identifier secret from the Electronic Clearing House, the Manufacturer does not need to expose the actual Coupon Instance Identifier to the Electronic Clearing House. The Electronic Clearing House matches the Encrypted Consumer Identifier with the Encrypted Coupon Instance Identifier and stores the matching pair of Identifiers for performing validation. The Electronic Clearing House uses a first Redemption Identifier Encryption Function to generate a Redemption Encrypted Identifier from the Encrypted Consumer Identifier and the Encrypted Coupon Instance Identifier. The Electronic Clearing House keeps the Encryption Key and Decryption Key of the Redemption Identifier Encryption Function1 a secret from the Retailer and Manufacturer. The generated Redemption Encrypted Identifier is downloaded to the Mobile Device corresponding to the Encrypted Consumer Identifier. One way to download the Redemption Encrypted Identifier to the Mobile Device is having the Mobile Devices receiving the download by a wireless connectivity from the Redemption Encrypted Identifier and providing the corresponding Encrypted Consumer Identifier in order to identify the corresponding Redemption Encrypted Identifier. Once the Redemption Encrypted Identifier receives the download via a wireless connectivity to the Mobile Device, a corresponding Bar Code representing the Redemption Encrypted Identifier is generated.

An embodiment of the one of the present inventions is an apparatus to redeem an electronic coupon comprising: a Mobile Device coupled to an operating system; the Mobile Device identifier identifies the Mobile Device in a plurality of Mobile Devices; a coupon identifier which identifies the electronic coupon in a plurality of electronic coupons; an electronic redemption process redeems the electronic coupon of a scanned bar code; and a coupon instance identifier identifies a single digital instance of the electronic coupon in an encrypted way that is not known by the electronic redemption process, further comprising: a mobile application displays the single digital instance of the electronic coupon on the Mobile Device, wherein a discount is provided to a consumer presenting the electronic coupon on the mobile device. The apparatus further comprising: an electronic coupon clearing process of the electronic coupon performed by an Electronic Clearing House, further comprising: at least one redemption parameter, a time of day and a date associated with the electronic coupon provided to the electronic coupon clearing process, further comprising: a Manufacturer receives legitimately counted redeemed electronic coupons from the Electronic Clearing House, wherein the Manufacturer reimburses a face value of the legitimately counted redeemed electronic coupons to a Retailer.

Another embodiment of the one of the present inventions is an apparatus for an electronic coupon comprising: a Mobile Device coupled to an operating system displays a digital instance of the electronic coupon; a bar code included in the digital instance of the electronic coupon presented to a Retailer; a bar code scanner of the Retailer scans the bar code; and an redemption identifier decryption function redeems a redemption encrypted identifier representing the electronic coupon of the scanned bar code. The apparatus further comprising: a mobile application displays the digital instance of the electronic coupon on the Mobile Device. The apparatus further comprising: at least one redemption parameter, a time of day and a date associated with the electronic coupon provided to the electronic redemption identifier decryption function, further comprising: a coupon instance identifier and a consumer identifier generated by the redemption identifier decryption function, wherein if the coupon instance identifier and the consumer identifier matches one of the redemption parameters then the redemption encrypted identifier representing the electronic coupon corresponds to a legitimate redemption of the electronic coupon, further comprising: a Manufacturer receives the legitimately redeemed electronic coupons to determine a final count, wherein the Manufacturer reimburses a face value of the legitimately counted redeemed electronic coupons to the Retailer.

Another embodiment of the one of the present inventions is an apparatus for a Multi-Key Identifier Encryption Function comprising: a Mobile Device coupled to an operating system displays a digital instance of an electronic coupon; a bar code scanner scans a bar code in the digital instance of the electronic coupon; a first plurality of identifiers provided by the bar code scanner; an identifier encryption function uses a first encryption key to compute an encrypted identifier; and a first decryption key used by an identifier decryption function to compute a plurality of first decrypted identifiers from the encrypted identifier matching the first plurality of identifiers in the bar code, further comprising: the first plurality of identifiers having a Mobile Device identifier, a consumer identifier, a coupon instance identifier and a redemption identifier; and a second plurality of identifiers having the Mobile Device identifier, the consumer identifier, the coupon instance identifier and the redemption identifier provided by the bar code scanner, further comprising: a second encryption key used by the identifier encryption function to compute the encrypted identifier, further comprising: a second decryption key used by the identifier decryption function to compute a second plurality of decrypted identifiers from the encrypted identifier matching the second plurality of identifiers in the bar code, further comprising: a time of day, a date, and a plurality of first parameters presented to the first encryption key; and the time of day, the date, and a plurality of second parameters presented to the second encryption key, further comprising: the first decryption key used by the identifier decryption function to compute a plurality of first decrypted parameters, the time of day, and the date from the encrypted identifier matching the first plurality of first parameters in the bar code, the time of day, and the date the electronic coupon was encrypted; and the second decryption key used by the identifier decryption function to compute a plurality of second decrypted parameters, the time of day, and the date from the encrypted identifier matching the second plurality of second parameters in the bar code, the time of day, and the date the electronic coupon was encrypted.

### BRIEF DESCRIPTION OF THE DRAWINGS

Please note that the drawings shown in this specification may not necessarily be drawn to scale and the relative dimensions of various elements in the diagrams are depicted schematically. The inventions presented here can be embodied in many different forms and should not be construed as limited to the embodiments set forth herein. Rather, these embodiments are provided so that this disclosure will be thorough and complete, and will fully convey the scope of the invention to those skilled in the art. In other instances, well-known structures and functions have not been shown or described in detail to avoid unnecessarily obscuring the description of the embodiment of the invention. Like numbers refer to like elements in the diagrams.

FIG. 1 shows a Manufacturer building a plurality of Products and generating a plurality of associated Manufacturer Coupon, a Retailer owning a plurality of Stores, and a Consumer.

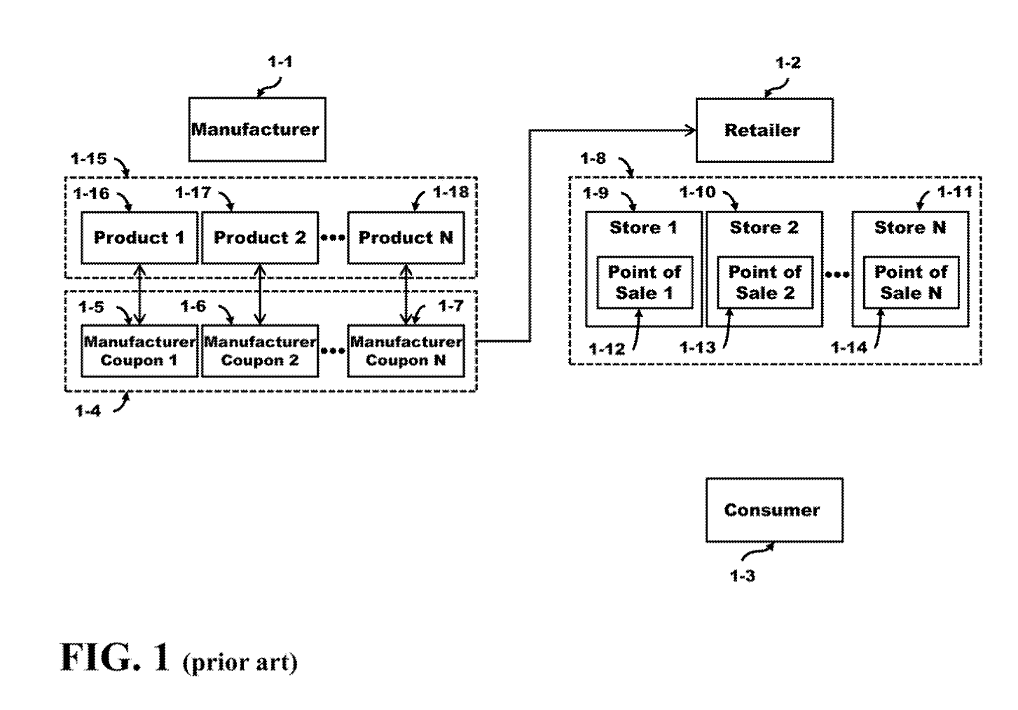

FIG. 2 shows a Retailer publishing a plurality of Coupons on Printed Media and a Consumer selecting Printed Coupons and carrying them to a store.

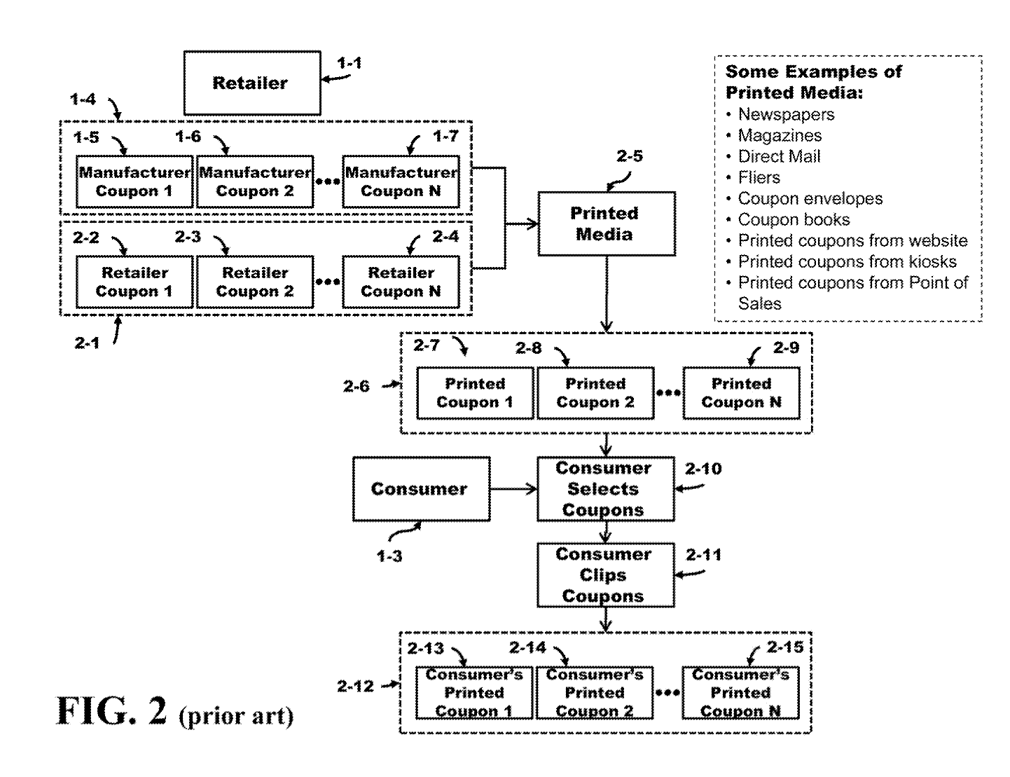

FIG. 3 illustrates how a Consumer redeems a Printed Coupon at a Store and receives an associated discount.

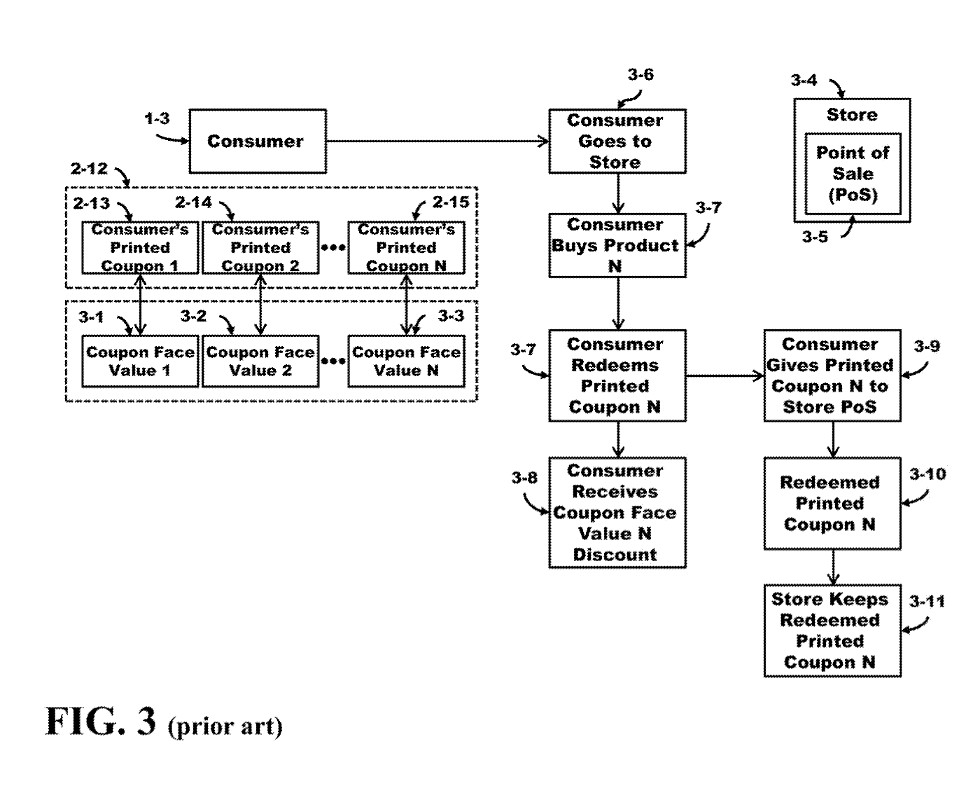

FIG. 4 illustrates the Coupon Clearing Process used by a Retailer and a Manufacturer to prevent Coupon Fraud using Printed Coupons

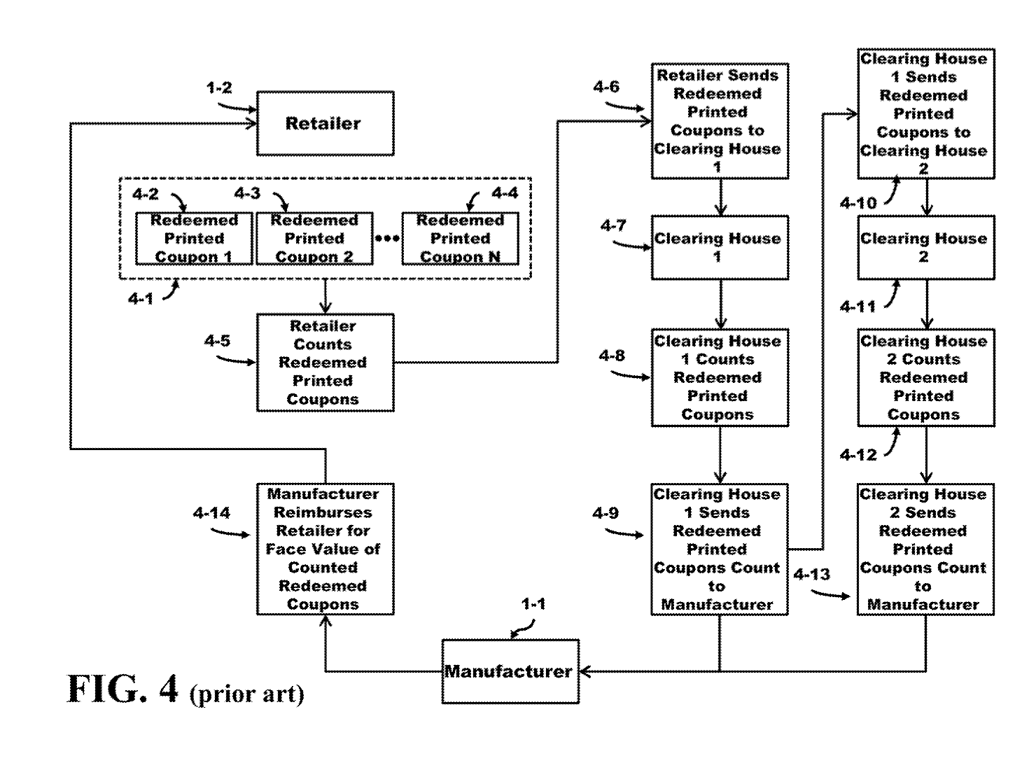

FIG. 5A shows a system used by a Retailer to distribute Electronic Coupons to a Mobile Device running a Mobile Application in accordance with an embodiment of the one of the present inventions.

FIG. 5B shows a system used by a Retailer to distribute Electronic Coupons to a Mobile Device running a Web Browser in accordance with an embodiment of the one of the present inventions.

FIG. 6A shows the structure of an Electronic Coupon containing a Bar Code and associated to various identifiers in accordance with an embodiment of the one of the present inventions.

FIG. 6B provides further details on the relationships between various identifiers in accordance with an embodiment of the one of the present inventions.

FIG. 7 illustrates the Electronic Redemption Process and the Electronic Coupon Clearing Process of an Electronic Coupon in accordance with an embodiment of the one of the present inventions.

FIG. 8A illustrates how a single Encrypted Identifier is encrypted and decrypted using an Identifier Encryption Function and an Identifier Decryption Function in accordance with an embodiment of the one of the present inventions.

FIG. 8B illustrates how a single Encrypted Identifier is encrypted and decrypted using an Multi-Key Identifier Encryption Function and a Multi-Key Identifier Decryption Function in accordance with an embodiment of the one of the present inventions.

FIG. 9 illustrates a system solution comprising Servers, Computing Devices, and Storage Devices and offering an Electronic Coupon Clearing Process to a Retailer and a Manufacturer using an Electronic Clearing House to clear Coupons redeemed by a Consumer using a Mobile Device in accordance with an embodiment of the one of the present inventions.

FIG. 10A shows an Identifier Generation and Distribution phase of a first embodiment of an Electronic Coupon Clearing Process in accordance with an embodiment of the one of the present inventions.

FIG. 10B shows an Identifier Clearing phase of a first embodiment of an Electronic Coupon Clearing Process in accordance with an embodiment of the one of the present inventions

FIG. 11 shows an Identifier Clearing phase of a second embodiment of an Electronic Coupon Clearing Process in accordance with an embodiment of the one of the present inventions.

FIG. 12 shows an Identifier Generation and Distribution phase third embodiment of an Electronic Coupon Clearing Process in accordance with an embodiment of the one of the present inventions.

### DETAILED DESCRIPTION OF THE INVENTION

The Coupon industry relies on Consumers using physical instances of Printed Coupons in order to prevent Coupon Fraud. For example, physical instances of Printed Coupons are easily validated as “legitimate” Coupons. For example, a physical instance of a Printed Coupon can be visually verified that it was clipped from a magazine or a newspaper by a Consumer and it was not copied or duplicated. Physical instances of redeemed Printed Coupons can be easily counted by independent entities, organizations, or individuals and can be easily validated in the Coupon Clearing Process. When physical instances of Coupons are used, the total number of redeemed Coupons is difficult to alter maliciously, since the entity or individual intending to commit Coupon Fraud would have to collect large numbers of physical instances of legitimate Coupons, which may be difficult, time consuming, and costly to do. The Coupon Clearing Process uses physical instances of redeemed Coupons and is based on the fact that there is a very high likelihood that those physical instances have been provided to the store by Consumers “legitimately,” i.e., as those Consumers came to the store to redeem those Coupons in conjunction with purchases of associated products. The Coupon Clearing Process does not eliminate Coupon Fraud, but makes substantially more difficult for any entity, organization, or individual to commit Coupon Fraud.

In recent years, the proliferation of smartphones and other mobile devices have made it possible for a Retailer, a Manufacturer, a Vendor, a Franchise, or other business to create and distribute Electronic Coupons to Consumers by downloading and displaying the Coupons on the mobile devices of those Consumers. Examples of mobile devices include cellular phones, smartphones like the iPhone™, Android™ and Blackberry™, wearable devices, and tablets. The mobile devices sends and receives communication to/from the internet by wireless connectivity (i.e., waves through space). The wireless connectivity can be cellular (3G, 4G, etc.), Wi-Fi, Bluetooth, WiMax, etc. The mobile devices may also sends and receives communication to/from the internet by wired connectivity (i.e., a physical interconnect).

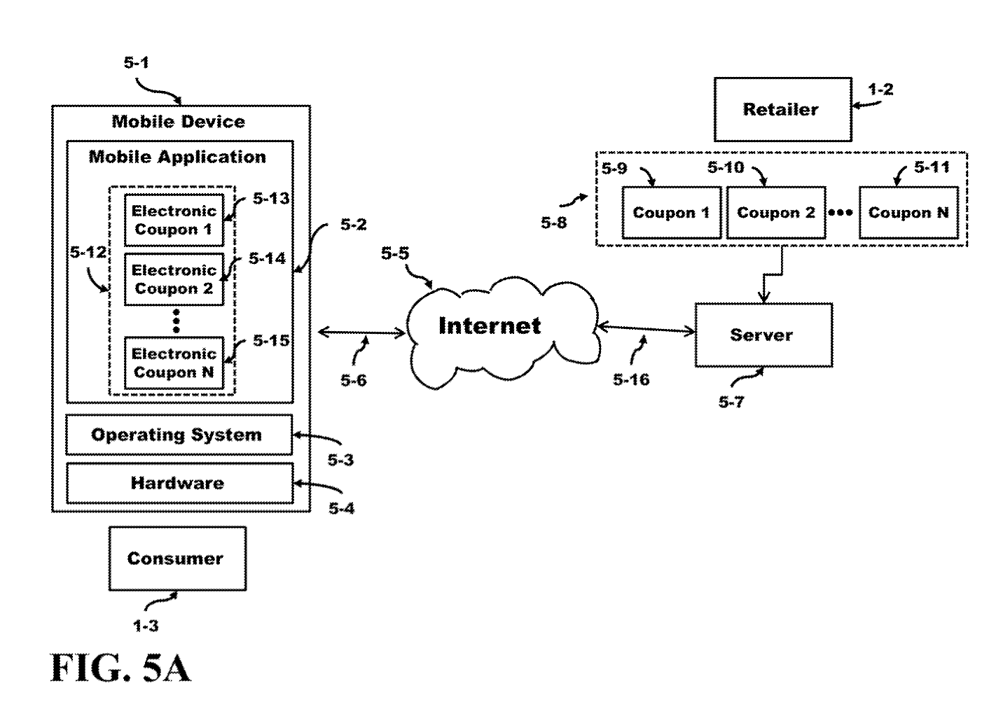

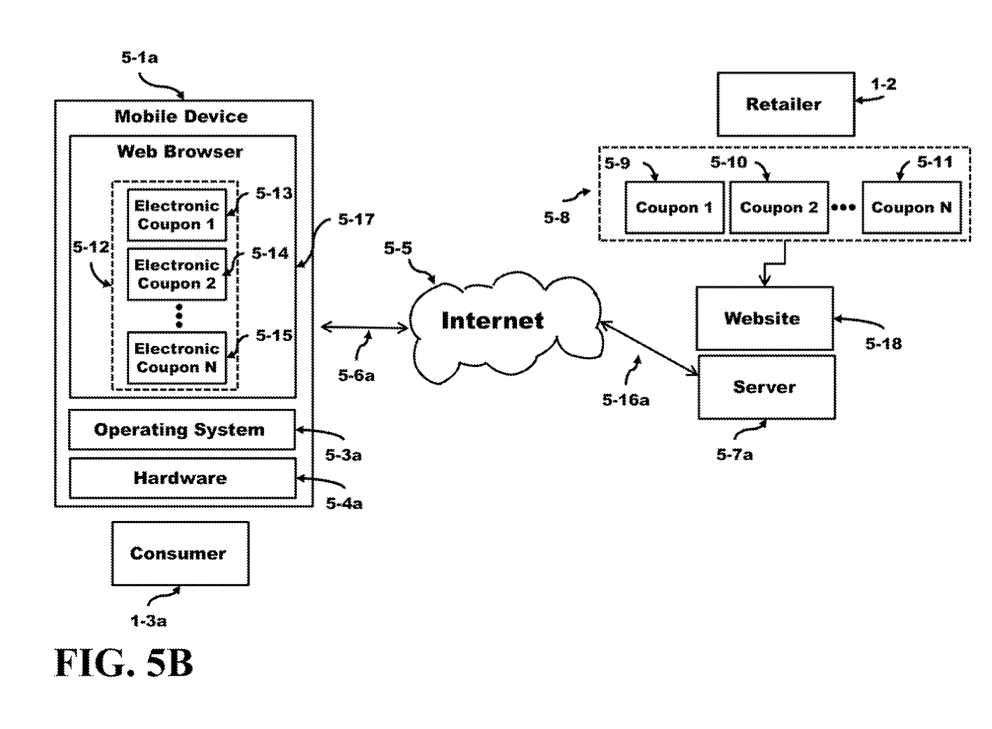

FIG. 5A and FIG. 5B illustrate different ways in which Electronic Coupons may be distributed and displayed to mobile devices. In FIG. 5A, a first mobile device 5-1 sends and receives communication 5-6 to/from the Internet 5-5. The Internet 5-5 is a communication system that provides connectivity to billions of users, entities, and organizations with mobile devices such as cellular phones, smartphones, wearable devices, and tablets and non-mobile devices such as servers, laptops, notebooks, desktops, and Internet Enabled TV sets. The first mobile device 5-1 comprises a Hardware 5-4 and an Operating System 5-3. A Mobile Application 5-2 runs on the Operating System 5-3 of the Mobile Device 5-1. A Retailer 1-2 creates a plurality of Coupons 5-8 comprising Coupon 1 5-9, Coupon 2 5-10, to Coupon N 5-11. These Coupons may include Retailer Coupons, Manufacturer Coupons, Franchise Coupons, or any type of Coupons. The Retailer 1-2 stores the plurality of Coupons 5-8 on a Server 5-7 sends and receives communication 5-16 to/from the Internet 5-5. The Coupons in the plurality of Coupons 5-8 are downloaded via the Internet 5-5 to the Mobile Device 5-1 and are displayed as a plurality of Electronic Coupons 5-12 comprising Electronic Coupon 1 5-13, Electronic Coupon 2 5-14, to Electronic Coupon N 5-15 to the Consumer 1-3 using the Mobile Application 5-2.

In FIG. 5B, a second mobile device 5-1a sends and receives communication 5-6a to/from the internet 5-5. The second mobile device 5-1a comprises a Hardware 5-4a and an Operating System 5-3a. A Web Browser 5-17 runs on the Operating System 5-3a of the Mobile Device 5-1a. The Retailer 1-2 stores the plurality of Coupons 5-8 on a Website 5-18 which runs on a Server 5-7a sends and receives communication 5-16a to/from the Internet 5-5. The Web Browser 5-17 accesses the Website 5-18 and downloads the plurality of Coupons 5-8 via the Internet 5-5 to the Mobile Device 5-1a, and displays the downloaded Coupons as a plurality of Electronic Coupons 5-12 to the Consumer 1-3.

Electronic Coupons may also be distributed to Consumer by displaying them on non-mobile devices, such as laptops, desktops, and TV sets. A person skilled in the art can devise proper modifications to what is described herein for a mobile device in order to apply to a non-mobile device.

Electronic Coupons have several advantages over Printed Coupons. A first advantage is that Electronic Coupons do not need to be printed, so the cost of creating an “instance” of an Electronic Coupon is lower than the cost of creating an “instance” of a Printed Coupon. In fact, an “instance” of a Printed Coupon is a physical instance, printed on paper. On the contrary, an “instance” of an Electronic Coupon is a “digital” instance (i.e., pixels displayed on a mobile device); each instance of an Electronic Coupon is displayed on a mobile device of a Consumer. The term Electronic Coupon also refers to any digital instance of an Electronic Coupon. The term Printed Coupon also refers to any printed instance of a Printed Coupon.

A second advantage is that an Electronic Coupon is more easily distributed to a Consumer than a Printed Coupon. Since a mobile device is typically a “personal” device associated with a Consumer (for example, a smartphone), displaying an Electronic Coupon on a mobile device distributes the Electronic Coupon to the Consumer associated with that mobile device. In case of a Printed Coupon, in order for the Coupon to reach a Consumer, the Printed Coupon has first to be printed on a Printed Media, for example a magazine or a newspaper. Then, the Consumer must buy or have access to the magazine or the newspaper containing the Printed Coupon in order to read it and become aware of the Printed Coupon. A third advantage is that an Electronic Coupon can be automatically stored on the mobile device, and does not need to be clipped or printed in order for a Consumer to be able to carry the Coupon to the store. For example, since a Consumer typically carries his/her smartphone when he/she visits a store, the Electronic Coupons are “automatically” available when the Consumer is at the store. With Printed Coupons, the desired Coupons have to be clipped or printed in order to be brought to the store, and the Consumer may forget the physical instances of the Coupons at home when he/she goes to the store. A fourth advantage is that Electronic Coupons may be sorted by the Mobile Application 5-2 running on the Mobile Device 5-1 or the Web Browser 5-17 running on the Mobile Device 5-1a according to different criteria, so a Consumer may more easily identify and select Electronic Coupons that are associated with products or services that the Consumer desires to purchase. The Consumer may use electronic search capabilities included in the Mobile Device to search for desired Coupons. With Printed Coupons, the Consumer must look at the Coupons manually and cannot use electronic search to search for them, nor can use a Mobile Application or a Web Browser to sort them in a way that is convenient for the Consumer. Because of all these advantages, Electronic Coupons are very convenient for the Consumer to use and are an effective form of incentive that Manufacturer, Retailers, Vendors, Franchises, and other business can use to promote their products or services.

However, since the digital instances of the Electronic Coupons are not physical instances, Electronic Coupons have one disadvantage with respect to Printed Coupons. Since an instance of an Electronic Coupon is not a “physical” instance, contrary to an instance of a Printed Coupon which is physical, Coupon Fraud is more difficult to prevent when Electronic Coupons are used. For example, digital instances of Electronic Coupons are easily duplicated, and the total number of Redeemed Electronic Coupons can be more easily altered maliciously than the total number of Redeemed Printed Coupons. After a Consumer redeems an Electronic Coupon and then leaves the store, there is no physical instance of that Coupon to be left behind as “proof” of the Redemption. The Coupon Clearing Process used to count and validate Redeemed Printed Coupons cannot be used to count and validate Redeemed Electronic Coupons because the Coupon Clearing Process relies on physical instances of the Coupons. One solution to this problem is to print a digital instance of the Electronic Coupons so a corresponding printed instance of the Coupon is created. Such physical printed instance of an Electronic Coupon can then be used in the same way as the physical printed instance of a Printed Coupon and the Coupon Clearing Process used for Printed Coupons can be used for the printed instances of Electronic Coupons. However, printing the Electronic Coupon is very inconvenient for Consumers, Retailers, Vendors, and other businesses and eliminates many of the advantages of the Electronic Coupon.

In order to benefit from the advantages of Electronic Coupons, it is desirable that the entire lifecycle of the Coupons, from the generation of the Coupons, to the distribution, to the Redemption Process, to the Clearing Process is all performed “electronically,” meaning that the digital instances of the Electronic Coupons are used throughout the lifecycle and printed instances are not required.

The fact that Coupon Fraud is more difficult to prevent when using Electronic Coupons (i.e., digital instances of Electronic Coupons) makes it difficult for Manufacturers and Retailers to use Electronic Coupons, since they may be more easily subject to Coupon Fraud.

It is an objective of the present invention to provide a System Solution that offers a Retailer and a Manufacturer an Electronic Coupon Clearing Process that uses digital instances of Electronic Coupons and provides the same guarantees of the Coupon Clearing Process used with physical instances of Printed Coupons to prevent Coupon Fraud (or, more precisely, to make it substantially more difficult for any entity, organization, or individual to commit Coupon Fraud).

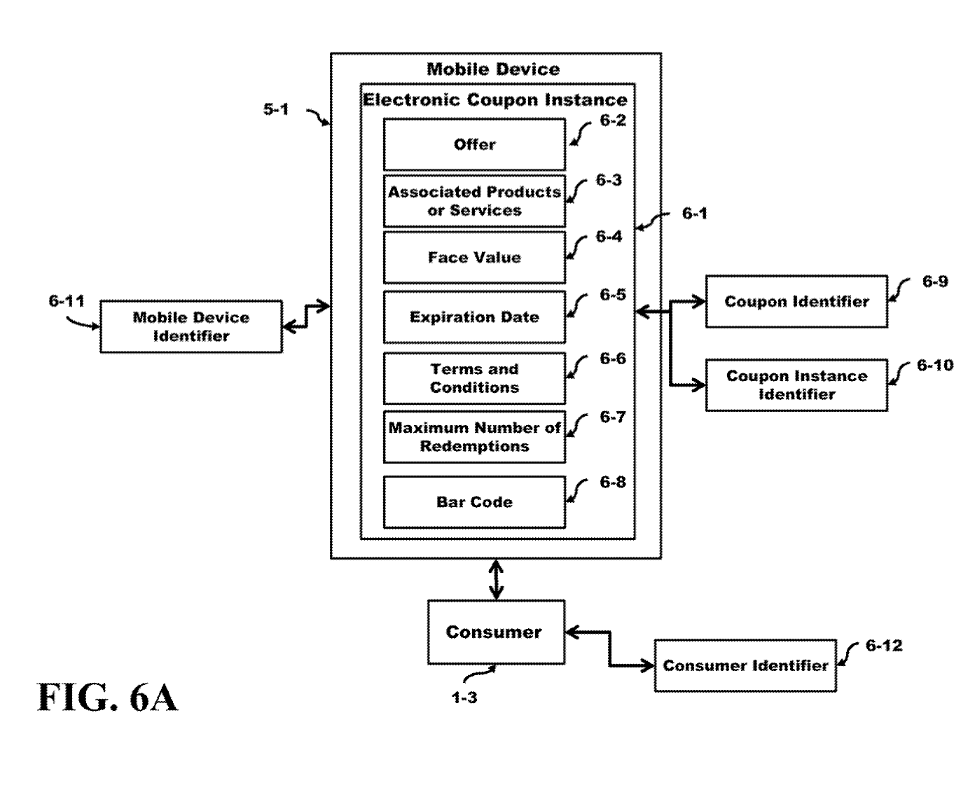

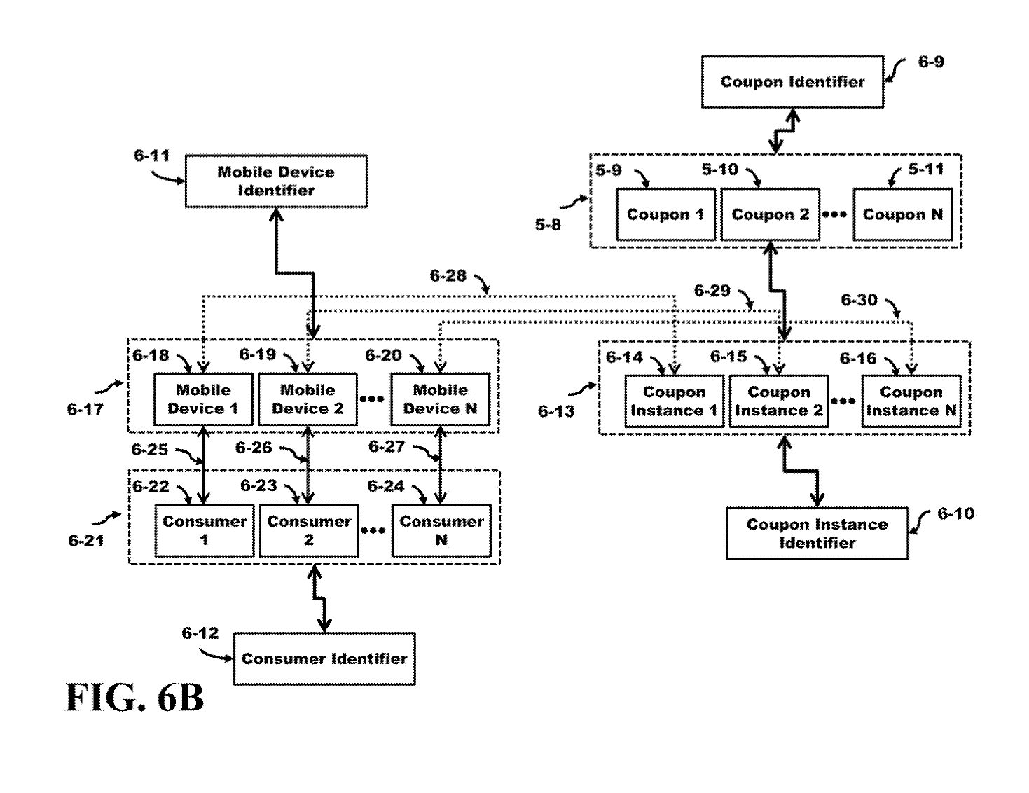

FIG. 6A illustrates the structure of an Electronic Coupon Instance 6-1, or more precisely the structure of a digital instance of an Electronic Coupon 6-1 displayed on a Mobile Device 5-1. An Electronic Coupon Instance 6-1, similarly to a Printed Coupon, contains an Offer 6-2 of a certain Face Value 6-4, associated with one or more Associated Products or Services 6-3, an Expiration Date 6-5, a Terms of Conditions 6-6, and a Maximum Number of Redemptions 6-7 which places a limit on the number of instances of the Electronic Coupon 6-1 that can be redeemed by Consumers. The Electronic Coupon Instance 6-1 may also contain a Bar Code 6-8 which may provide an Identifier which can be scanned by a Bar Code Scanner. The Electronic Coupon 6-1 is associated with a Coupon Identifier 6-9 which identifies this Coupon in the plurality of Coupons that a Manufacturer, a Retailer, a Vendor, a Franchise or other businesses may distribute. The digital instance of the Electronic Coupon 6-1 displayed on the Mobile Device 5-1 is also associated with a Coupon Instance Identifier 6-10 which identifies the digital instance displayed on the Mobile Device 5-1 in the plurality of digital instances of Electronic Coupon 6-1. The Mobile Device 5-1 is associated with a Mobile Device Identifier 6-11 which identifies the Mobile Device 5-1 in the plurality of Mobile Devices on which the Electronic Coupon is displayed. The Mobile Device 5-1 is also associated with a Consumer 1-3, who in turn may be associated with a Consumer Identifier 6-12 which identifies the Consumer 1-3 in the plurality of all Consumers using Electronic Coupons.

FIG. 6B provides further details on the relationships of the different identifiers. The Mobile Device Identifier 6-11 identifies the Mobile Device in the plurality of Mobile Devices 6-17 comprising Mobile Device 1 6-18, Mobile Device 2 6-19, to Mobile Device N 6-20. The Consumer Identifier 6-12 identifies the Consumer in the plurality of Consumers 6-21, comprising Consumer 1 6-22, Consumer 2 6-23, to Consumer N 6-24. A Consumer 1 6-22 may be associated with a Mobile Device 1 6-18, a Consumer 2 6-23 may be associated with a Mobile Device 2 6-19, and a Consumer N 6-24 may be associated with a Mobile Device N 6-20. Because of these associations, a Mobile Device Identifier may be used to identify the associated Consumer, and a Consumer Identifier may be used to identify the associated Mobile Device.

A Coupon Identifier 6-9 identifies a Coupon in the plurality of Coupons 5-8, comprising Coupon 1 5-9, Coupon 2 5-10, to Coupon N 5-11. For each Coupon in the plurality of Coupons 5-8, a Coupon Instance identifier 6-10 identifies the digital instance of that Coupon in the associated plurality of digital instances for that Coupon. For example, the plurality of Coupon Instances 6-13 corresponds to Coupon 2 5-10 and comprises Coupon Instance 1 6-14, Coupon Instance 2 6-15, to Coupon instance N 6-16. Each Coupon Instance in the plurality of Coupon Instances 6-13 is displayed on a Mobile Device in the plurality of Mobile Devices 6-17. For example, Coupon Instance 1 6-14 is associated with Mobile Device 1 6-18, which in turn is associated with Consumer 1 6-22, Coupon Instance 2 6-15 is associated with Mobile Device 1 6-19, which in turn is associated with Consumer 1 6-23, and Coupon Instance N 6-16 is associated with Mobile Device N 6-20, which in turn is associated with Consumer N 6-24.

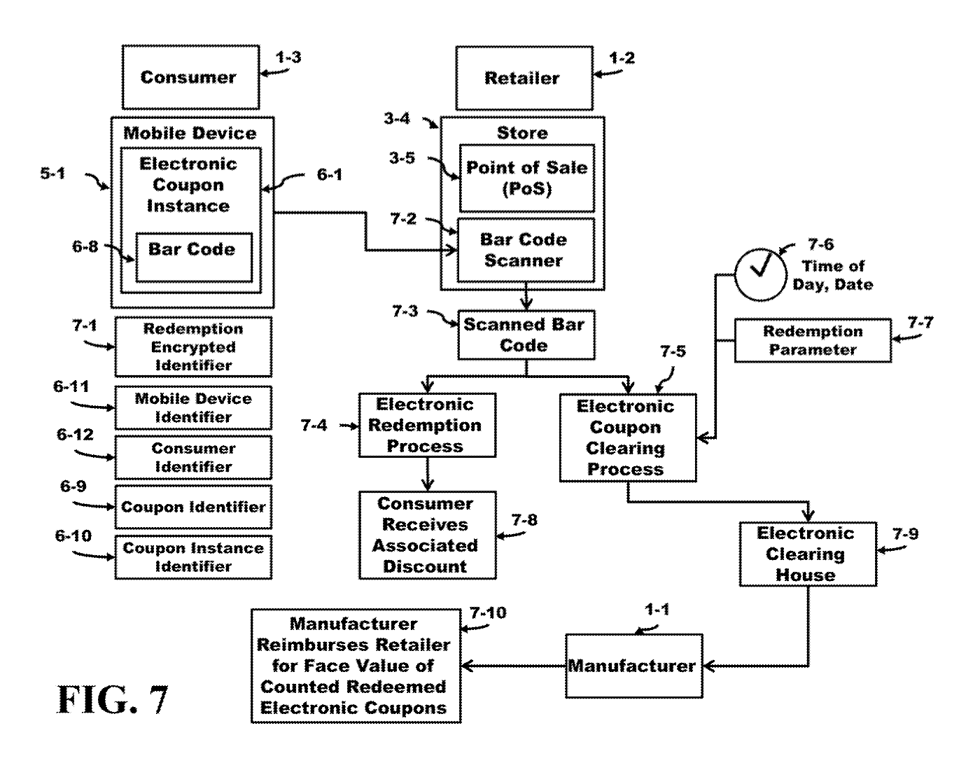

Electronic Coupons can be redeemed and cleared electronically in accordance with the present invention, as illustrated in FIG. 7. A Consumer 1-3 goes to a Store 3-4 belonging to Retailer 1-2. The Consumer 1-3 carries an Electronic Coupon Instance 6-1 displayed on a Mobile Device 5-1. A corresponding Mobile Device Identifier 6-11, Consumer Identifier 6-12, Coupon Identifier 6-9, and Coupon Instance Identifier 6-10 are also shown. The Electronic Coupon Instance 6-1 contains a Bar Code 6-8. The Bar Code 6-8 can also be a QR code or any other form of representation of an electronic code that can be read by a scanner device. The Bar Code 6-8 encodes a Redemption Encrypted Identifier 7-1 computed in accordance with the present invention. The Store 3-4 contains a Point of Sale (PoS) 3-5 which has a Bar Code Scanner 7-2 capable of reading the Bar Code 6-8. The Consumer 1-3 desires to purchase a product or service associated with the Electronic Coupon Instance 6-1. When the Consumer 1-3 goes to the Point of Sale (PoS) 3-5 to pay for his/her desired purchase, the Consumer 1-3 presents his/her Mobile Device to the operator of the Point of Sale (PoS) 3-5, so the Bar Code 6-8 can be scanned. The Scanned Bar Code 7-3 is used by the Electronic Redemption Process 7-4 to redeem the Electronic Coupon 6-1. Once the Electronic Coupon is redeemed the “Consumer Receives Associated Discount” 7-8. The Scanned Bar Code 7-3, which represents the Redemption Encrypted Identifier 7-1, is also used as input for the Electronic Coupon Clearing Process 7-5 in accordance with the present invention. A Time of Day, Date 7-6 and a Redemption Parameter 7-7 may also be used as inputs for the Electronic Coupon Clearing Process 7-5. For example, the Time of Day, Date of when the Bar Code 6-8 was scanned may be used as Time of Day, Date 7-6. More than one Redemption Parameter may be used as input of the Electronic Coupon Clearing Process 7-5. For example, the geographical location of the Store 3-4 may be used as Redemption Parameter 7-7.

The Electronic Coupon Clearing Process 7-5 may be performed by an Electronic Clearing House 7-9. The Electronic Clearing House 7-9 may be independent from the Retailer 1-2 and Manufacturer 1-1. The output of the Electronic Clearing House 7-9 is fed to the Manufacturer 1-1, so the Manufacturer 1-1 can compute the Face Value of the legitimately Redeemed Electronic Coupons. Then, the “Manufacturer Reimburses Retailer for Face Value of Counted Redeemed Electronic Coupons” 7-10 and the Electronic Clearing Process is concluded.

The Electronic Coupon Clearing Process for Electronic Coupons serves the same purpose of the Coupon Clearing Process used for the clearing of physical instances of Printed Coupons. Specifically, the Electronic Coupon Clearing Process gives the Manufacturer 1-1 confidence that the instance of the Electronic Coupon has indeed been redeemed by a Consumer 1-3 in association with a purchase of an associated product and that the number of Redeemed Electronic Coupons have not been fraudulently inflated by the Retailer 1-2. The Electronic Coupon Clearing Process also allows the Retailer 1-2 and Manufacturer 1-1 to track the instances of Electronic Coupons and the associated Mobile Devices and Consumer that redeem those instances. In case of a dispute on the number of Redeemed Electronic Coupons, the Retailer 1-2 and Manufacturer 1-1 can use the data collected as part of the Electronic Redemption Process and Electronic Coupon Clearing Process to support their computations and provide details of which Consumers redeemed which instances at what time and in which stores.

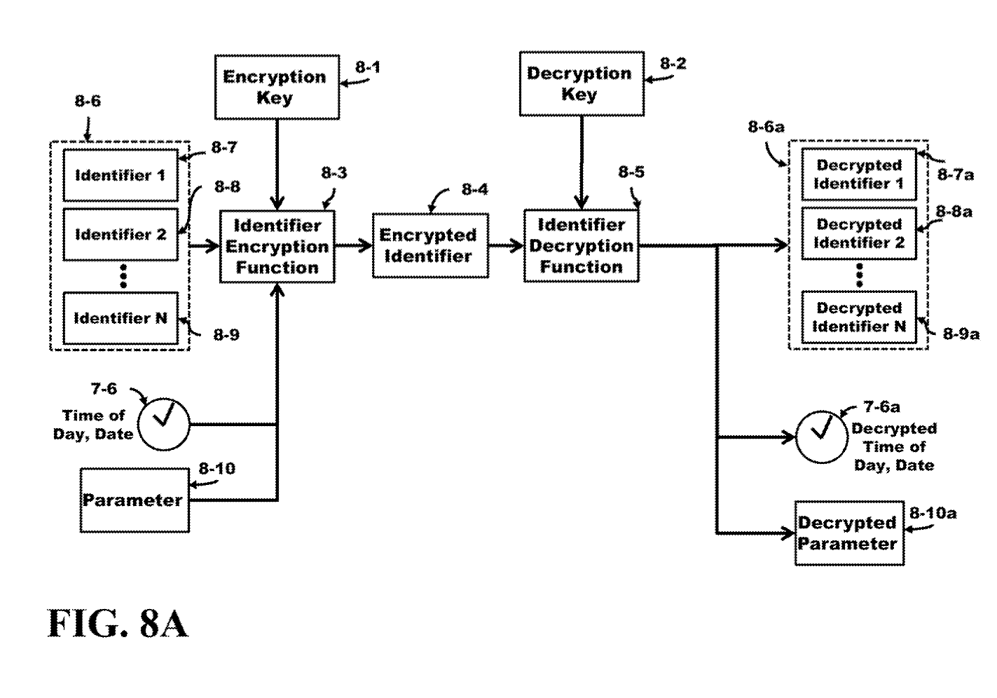

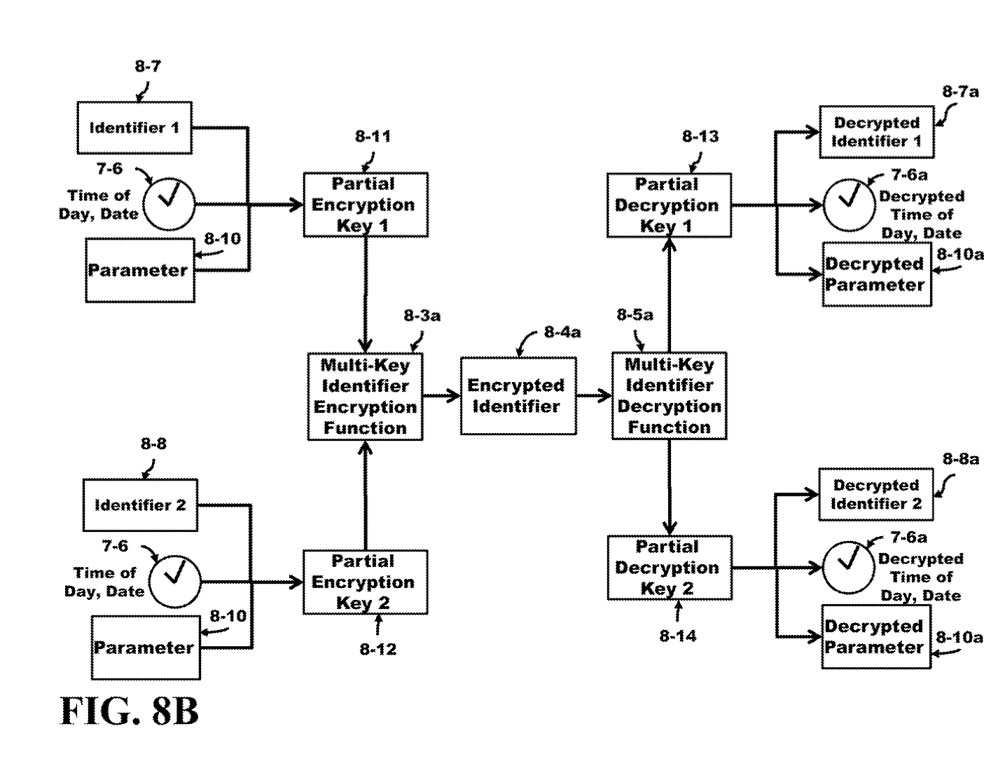

The Electronic Coupon Clearing Process 7-5 is based on computing and verifying a Redemption Encrypted Identifier 7-1 which offers certain properties. FIG. 8A illustrates how an Encrypted Identifier 8-4 is computed. An Identifier Encryption Function 8-3 uses as inputs a plurality of Identifiers 8-6, comprising Identifier 1 8-7, Identifier 2 8-8, and Identifier N 8-9. For example, the Coupon Instance Identifier 6-10, the Mobile Device Identifier 6-11 or the Consumer Identifier 6-12 may be in such plurality of Identifiers 8-6. A Time of Day, Date 7-6 and a Parameter 8-10 may also be used as inputs of the Encryption Function 8-3. The Identifier Encryption Function 8-3 uses an Encryption Key 8-1 to compute a single Encrypted Identifier 8-4. A property of the Identifier Encryption Function is that there is an Identifier Decryption Function 8-5 which, when applied to such single Encrypted Identifier 8-4 using a Decryption Key 8-2, computes a plurality of Decrypted Identifiers 8-6a, comprising Decrypted Identifier 1 8-7a, Decrypted Identifier 2 8-8a, and Decrypted Identifier N 8-9a. It also computes a Decrypted Time of Day, Date 7-6a and Decrypted Parameter 8-10a. If the Identifier Decryption Function 8-5 is applied to the Encrypted Identifier 8-4 computed by the Identifier Encryption Function 8-3, the plurality of Decrypted Identifiers 8-6a, the Decrypted Time of Day, Date 7-6a, and the Decrypted Parameter 8-10a are identical to the plurality of Identifiers 8-6, Time of Day, Date 7-6, and Parameter 8-10 that were the inputs of the Identifier Encryption Function 8-3.

The Identifier Encryption Function 8-3 may be a “secret,” meaning that not all entities, organizations, or individuals involved in the Electronic Coupon Clearing Process 7-5 may have knowledge of the Identifier Encryption Function 8-3. The Encryption Key 8-1, the Identifier Decryption Function 8-5, and the Decryption Key 8-2 may also be a secret and not be known by all entities, organizations, or individuals involved in the Electronic Coupon Clearing Process 7-5. By controlling which entities, organizations, or individuals know the Identifier Encryption Function 8-3, Encryption Key 8-1, Identifier Decryption Function 8-5, and Decryption Key 8-2, it is possible to control who can encrypt and decrypt the Encrypted Identifier 8-4 and build a System Solution that offers a Retailer 1-2 and a Manufacturer 1-1 an Electronic Coupon Clearing Process that performs the clearing of redeemed Electronic Coupons.

FIG. 8B shows a variation of the ways the Encrypted Identifier 8-4 is encrypted and decrypted by a Multi-Key Identifier Encryption Function 8-3a and a Multi-Key Identifier Decryption Function 8-5. In this case, multiple Encryption Keys and Decryption Keys are used, each Encryption Key and Decryption Key acting on a subset of the inputs of the Multi-Key Identifier Encryption Function 8-3a. For example, a first Partial Encryption Key 1 8-11 is used in the Multi-Key Identifier Encryption Function 8-3a on a first Identifier 1 8-7, Time of Day, Date 7-6, and Parameter 8-10, and a second Partial Encryption Key 2 8-12 is used in the Multi-Key Identifier Encryption Function 8-3a on a second Identifier 1 8-8, Time of Day, Date 7-6, and Parameter 8-10. Similarly, the Multi-Key Identifier Decryption Function 8-5a uses a first Partial Decryption Key 1 8-13 to compute a first Decrypted Identifier 1 8-7a, Decrypted Time of Day, Date 7-6a, and Decrypted Parameter 8-10a, and uses a second Partial Decryption Key 2 8-14 to compute a second Decrypted Identifier 1 8-8a, Decrypted Time of Day, Date 7-6a, and Decrypted Parameter 8-10a. The Partial Encryption Keys and Partial Decryption Keys offer further control on which keys are known by which entities, organizations, or individuals involved in the Coupon Clearing Process.

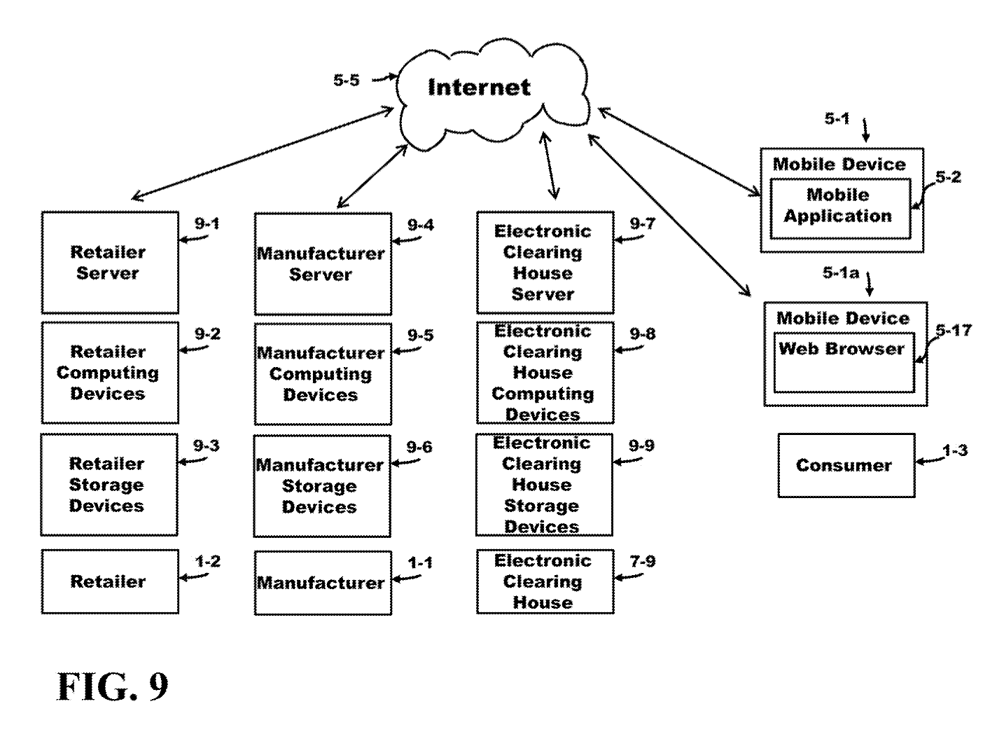

A System Solution providing an Electronic Clearing Process in accordance with the present invention is illustrated in FIG. 9. The Retailer 1-2 has one or more Retailer Server 9-1 that sends and receives communication to/from the Internet 5-5 together with Retailer Storage Devices 9-3 capable of storing and distributing the Electronic Coupons, and capable of storing Consumer Identifiers, Redemption Encrypted Identifiers that are scanned at the Retailer's store, Time of Day, Date of when Redemption Encrypted Identifiers are scanned, other identifiers, and other information. The Retailer Server 9-1 is also capable of sending Consumer Identifiers and other Identifiers to the Electronic Clearing House Server 9-7 and receiving Identifiers and other data from the Electronic Clearing House. The Retailer 1-2 has also Retailer Computing Devices 9-2 capable of encrypting and decrypting Encrypted Identifiers using Identifier Encryption Functions, Identifier Decryption Functions, Multi-Key Identifier Encryption Functions and Multi-key Decryption Functions.

The Manufacturer 1-1 has one or more Manufacturer Server 9-4 that sends and receives communication to/from the Internet 5-5 together with Manufacturer Storage Devices 9-6 capable of storing and distributing Electronic Coupons, and capable of storing Coupon Identifiers, Coupon Instance Identifiers, other identifiers, and other information. The Manufacturer Server 9-6 is also capable of sending Coupon Instance Identifiers and other Identifiers to the Electronic Clearing House Server 9-7 and receiving Identifiers and other data from the Electronic Clearing House. The Manufacturer 1-1 has also Manufacturer Computing Devices 9-5 capable of encrypting and decrypting Encrypted Identifiers using Identifier Encryption Functions, Identifier Decryption Functions, Multi-Key Identifier Encryption Functions and Multi-key Decryption Functions.

The Electronic Clearing House 7-9 has one or more Electronic Clearing House Server 9-7 that sends and receives communication to/from the Internet 5-5 together with Electronic Clearing House Storage Devices 9-9 capable of storing Consumer Identifiers and Coupon Instance Identifiers, Redemption Encrypted Identifiers that are scanned at the Retailer's store, Time of Day, Date of when Redemption Encrypted Identifiers are scanned, other identifiers, and other information. The Electronic Clearing House Server 9-7 is also capable of sending Identifiers to the Retailer Server 9-1 and Manufacturer Server 9-4 and of sending Redemption Encrypted Identifiers to a Mobile Device 5-1 running a Mobile Application 5-2 and to a Mobile Device 5-1a running a Web Browser 5-17. The Mobile Device 5-1 and Mobile Device 5-1a both receives the Redemption Encrypted Identifiers from the Internet as illustrated in FIG. 9. The Electronic Clearing House 7-9 has also Electronic Clearing House Computing Devices 9-9 capable of encrypting and decrypting Encrypted Identifiers using Identifier Encryption Functions, Identifier Decryption Functions, Multi-Key Identifier Encryption Functions and Multi-key Decryption Functions.

The Consumer 1-3 has a Mobile Device 5-1 that sends and receives communication to/from the Internet 5-5 running a Mobile Application 5-2 or a Mobile Device 5-1a running a Web Browser 5-17. The Mobile Application 5-2 and the Web Browser 5-17 are capable to access the Retailer Server 9-1 to download Electronic Coupons and to access the Electronic Clearing House Server to download Redemption Encrypted Identifiers. The Mobile Application 5-2 and the Web Browser 5-17 may also be capable of generating Encrypted Identifiers using Identifier Encryption Functions or Multi-Key Identifier Encryption Functions.

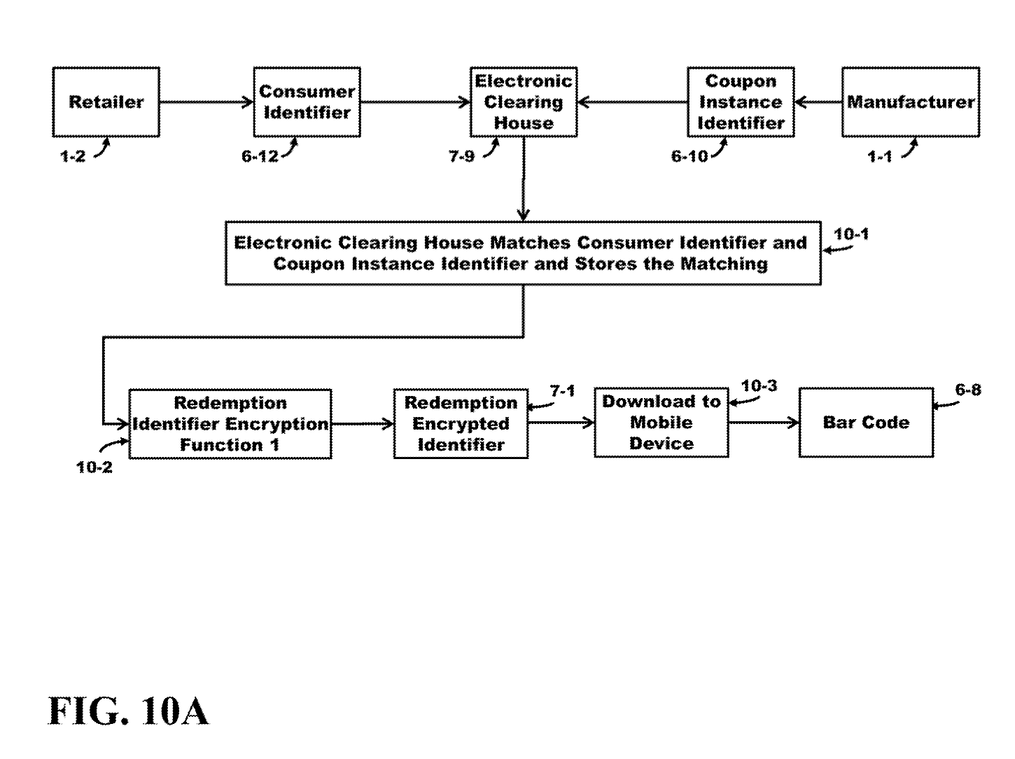

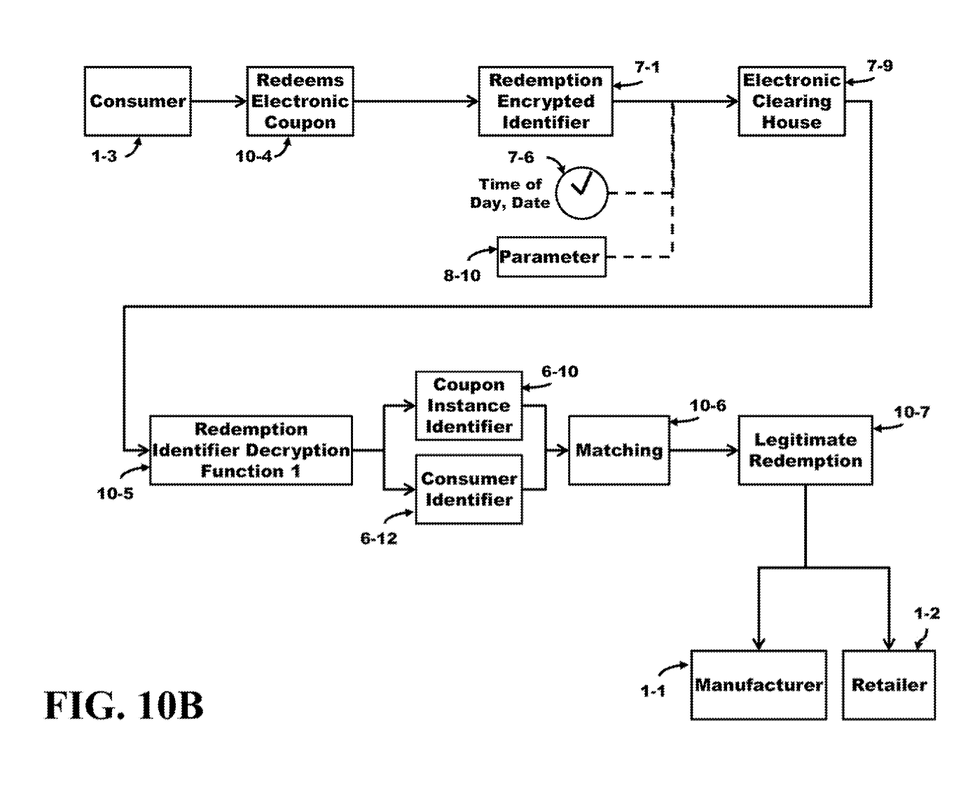

One of the embodiments of the present invention includes the Electronic Coupon Clearing Process illustrated in FIG. 10A and FIG. 10B. The Electronic Coupon Clearing Process consists of two phases: an Identifier Generation and Distribution phase and an Identifier Clearing phase. The Identifier Generation and Distribution phase in this embodiment of the present invention is shown in FIG. 10A. A Retailer 1-2 sends a Consumer Identifier 6-12 which identifies a Consumer in the plurality of Consumers 6-21 to an Electronic Clearing House 7-9. A Manufacturer 1-1 sends a Coupon Instance Identifier 6-10 which identifies a Coupon Instance in the plurality of Coupon Instances 6-13 to the Electronic Clearing House 7-9. The Electronic Clearing House 7-9 matches the Consumer Identifier 6-12 with the Coupon Instance Identifier 6-10 and stores the matching pair of Identifiers for performing validation at a later time. This is accomplished in the step “Electronic Clearing House Matches Consumer Identifier and Coupon Instance Identifier and Stores the Matching” 10-1. The Electronic Clearing House 7-9 uses a first Redemption Identifier Encryption Function 1 10-2 to generate a Redemption Encrypted Identifier 7-1 from the Consumer Identifier 6-12 and the Coupon Instance Identifier 6-10. The Electronic Clearing House 7-9 keeps the Encryption Key and Decryption Key of the Redemption Identifier Encryption Function 1 10-2 a secret from the Retailer 1-2 and Manufacturer 1-1. Thus, the Retailer 1-2 and Manufacturer 1-1 are not able to encrypt and decrypt Redemption Encrypted Identifiers.

The generated Redemption Encrypted Identifier 7-1 is downloaded to the Mobile Device corresponding to the Consumer Identifier 6-12 which receives the download by a wired or wireless connectivity. This “Download to Mobile Device” 10-3 may be accomplished in different ways. A preferred way to download the Redemption Encrypted Identifier to the Mobile Device is having the Mobile Device 5-1 or Mobile Device 5-1a downloading the Redemption Encrypted Identifier 7-1 directly to the Mobile Application 5-2 or Web Browser 5-17 by directly accessing the Electronic Clearing House Server 9-7 via the Internet and downloading the corresponding Consumer Identifier 6-12 in order to identify the corresponding Redemption Encrypted Identifier 7-1. A less preferable but possible way to download the Redemption Encrypted Identifier to the Mobile Device is for the Electronic Clearing House Server 9-7 to send the generated Redemption Encrypted identifier to the Retailer Server 9-1 and included in the corresponding instance of the Electronic Coupon is received by the Mobile Device. Once the Redemption Encrypted Identifier 7-1 is downloaded to the Mobile Device, a corresponding Bar Code 6-8 representing the Redemption Encrypted Identifier is generated.

The Identifier Clearing phase in this one of the embodiments of the present invention is shown in FIG. 10B. When a Consumer 1-3 “Redeems Electronic Coupon” 10-4 at a Retailer's store, the corresponding Bar Code representing the Redemption Encrypted Identifier 7-1 is scanned and stored in the Retailer Storage Devices 9-3. The Redemption Encrypted Identifier 7-1 is sent to the Electronic Clearing House 7-9 to validate that the Electronic Coupon was indeed redeemed by a Consumer at the store in conjunction with a purchase of an associated product. The Time of Day, Date 7-6 of when the Redemption Encrypted Identifier was scanned and a Parameter 8-10 such as the location of the Store where the Redemption Encrypted Identifier may also be sent to the Electronic Clearing House 7-9 as additional data in support that the redemption indeed occurred at that time and in that store. The Electronic Clearing House 7-9 uses a Redemption Identifier Decryption Function 1 10-5 corresponding to the first Redemption Identifier Encryption Function 1 10-2 to compute a Coupon Instance Identifier 6-10 and a Consumer Identifier 6-12. Then, in the “Matching” 10-6 step, if the computed Coupon Instance identifier 6-10 and Consumer Identifier 6-12 match with the pair of identifiers stored in step 10-1, the Electronic Clearing House 7-9 declares the redemption a Legitimate Redemption 10-7 and informs the Manufacturer 1-1 and Retailer 1-2. The Identifier Clearing phase may be executed each time an Electronic Coupon is redeemed, or at regular intervals, in which case the Electronic Clearing House 7-9 validates all the Redemptions that have occurred in that interval in batch mode and communicates the total number of Legitimate Redemptions to the Manufacturer 1-1 and Retailer 1-2.

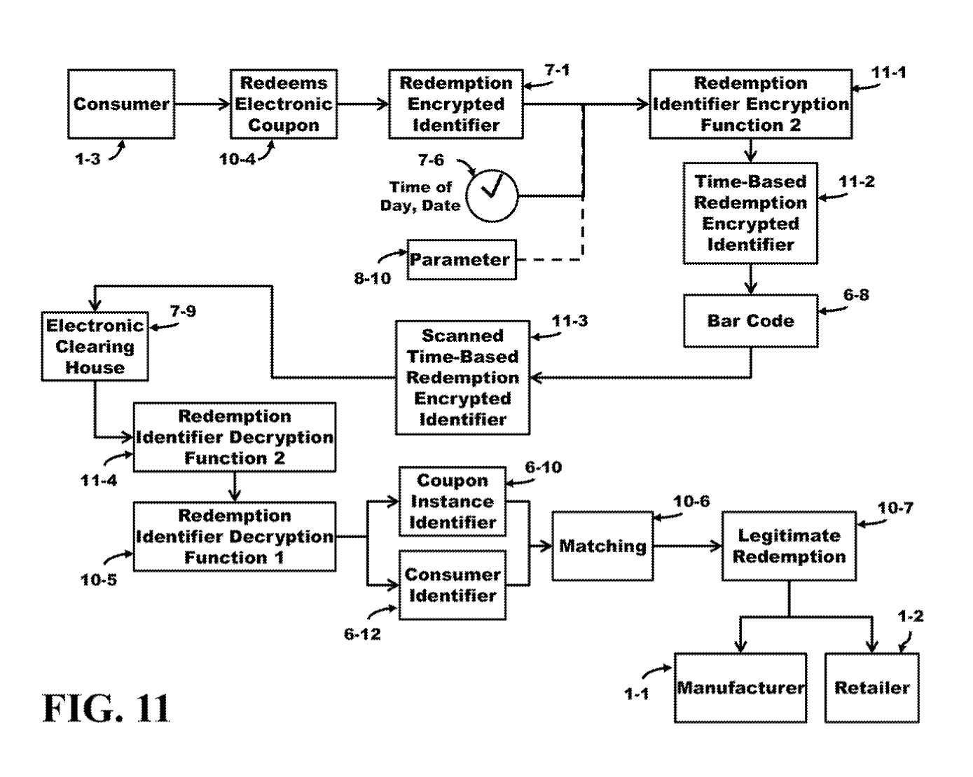

Another one of the embodiments of the present invention uses a different way to generate the Redemption Encrypted Identifier that is sent to the Electronic Clearing House to be used in the Identifier Clearing Phase. The Identifier Clearing phase in this embodiment of the present invention is shown in FIG. 11. The Bar Code 6-8 is not generated when the Redemption Encrypted Identifier 7-1 is downloaded or received by to the Mobile Device. When a Consumer 1-3 “Redeems Electronic Coupon” 10-4 at a Retailer's store, the Mobile Application 5-2 or Web Browser 5-17 uses a second Redemption Identifier Encryption Function 2 11-1 which uses the Redemption Encrypted Identifier 7-1 and the Time of Day, Date 7-6 corresponding to when the Electronic Coupon is ready to be scanned at the Point of Sale (PoS) 3-5 at the Store 3-4 to generate a Time-Based Redemption Encrypted Identifier 11-2, and a Bar Code 6-8 representing the Time-Based Redemption Encrypted Identifier 11-2. A Parameter 8-10 may also be used by the Redemption Identifier Encryption Function 2 11-1. When the Bar Code 6-8 is scanned, the Scanned Time-Based Redemption Encrypted Identifier 11-3 is sent to the Electronic Clearing House 7-9. The Encryption Key of the Redemption Identifier Encryption Function 2 is a secret for the Retailer 1-2, so the Retailer 1-2 cannot generate the Time-Based Redemption Encrypted Identifier 11-2. The Electronic Clearing House 7-9 uses a Redemption Identifier Decryption Function 2 11-4 corresponding to the second Redemption Identifier Encryption Function 2 11-1 to compute the Redemption Encrypted Identifier 7-1 from the Scanned Time-Based Redemption Encrypted Identifier 11-3. Then, the Electronic Clearing House 7-9 uses a Redemption Identifier Decryption Function 1 10-5 corresponding to the first Redemption identifier Encryption Function 1 10-2 to compute a Coupon Instance Identifier 6-10 and a Consumer Identifier 6-12 from the Redemption Encrypted Identifier 7-1. Then, in the “Matching” 10-6 step, if the computed Coupon Instance Identifier 6-10 and Consumer Identifier 6-12 match with the pair of identifiers stored in step 10-1, the Electronic Clearing House 7-9 declares the redemption a Legitimate Redemption 10-7 and informs the Manufacturer 1-1 and Retailer 1-2.

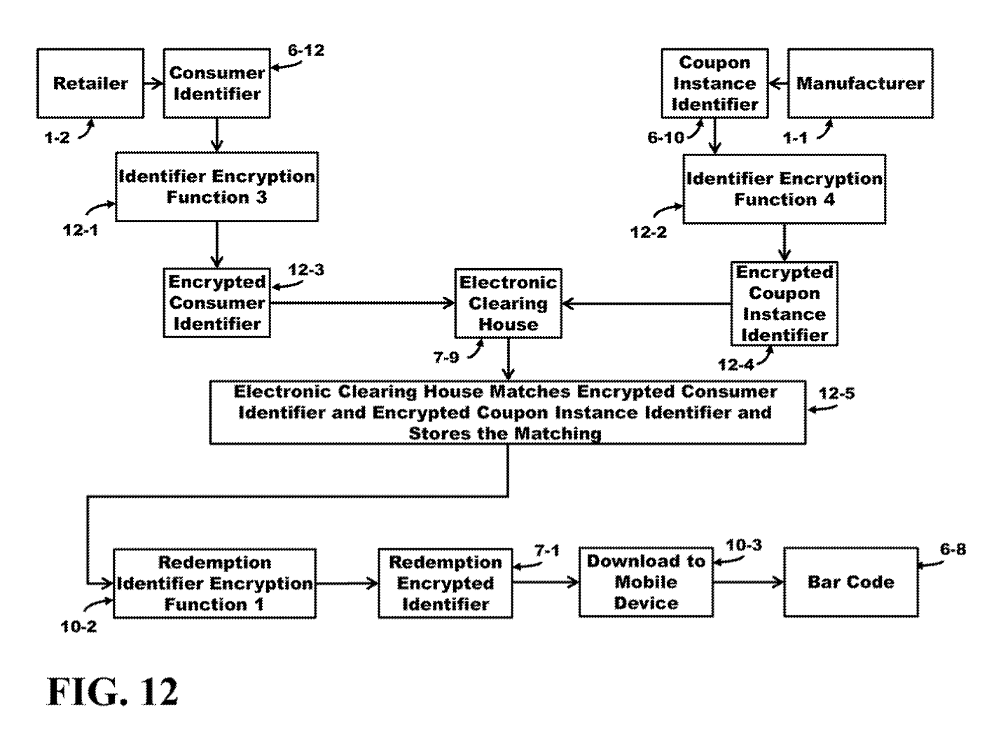

FIG. 12 shows an Identifier Generation and Distribution phase included in another one of the embodiments of an Electronic Coupon Clearing Process in accordance with the present invention. This embodiment is used if the Retailer 1-2 does not want to disclose the Consumer Identifier 6-12 to the Electronic Clearing House 7-9 or the Manufacturer 1-1 does not want to disclose the Coupon Instance Identifier 6-10 to the Electronic Clearing House 7-9. In this case, the Retailer 1-2 generates an Encrypted Consumer Identifier 12-3 using an Identifier Encryption Function 3 12-1 such as the one described in FIG. 8A and sends the Encrypted Consumer Identifier 12-3 to the Electronic Clearing House 7-9. If the Retailer keeps the Decryption Key of such Encrypted Consumer Identifier 12-3 secret from the Electronic Clearing House 7-9, the Retailer does not need to expose the actual Consumer Identifier 6-12 to the Electronic Clearing House 7-9. Similarly, the Manufacturer 1-1 generates an Encrypted Coupon Instance Identifier 12-4 using an Identifier Encryption Function 4 12-2 such as the one described in FIG. 8A and sends the Encrypted Coupon Instance Identifier 12-4 to the Electronic Clearing House 7-9. If the Manufacturer keeps the Decryption Key of such Encrypted Coupon Instance Identifier 12-4 secret from the Electronic Clearing House 7-9, the Manufacturer does not need to expose the actual Coupon Instance Identifier 6-10 to the Electronic Clearing House 7-9. The Electronic Clearing House 7-9 matches the Encrypted Consumer Identifier 12-3 with the Encrypted Coupon Instance Identifier 12-4 and stores the matching pair of Identifiers for performing validation at a later time. This is accomplished in the step “Electronic Clearing House Matches Encrypted Consumer Identifier and Encrypted Coupon Instance Identifier and Stores the Matching” 12-5. The Electronic Clearing House 7-9 uses a first Redemption Identifier Encryption Function 1 10-2 to generate a Redemption Encrypted Identifier 7-1 from the Encrypted Consumer Identifier 12-3 and the Encrypted Coupon Instance Identifier 12-4. The Electronic Clearing House 7-9 keeps the Encryption Key and Decryption Key of the Redemption Identifier Encryption Function 1 10-2 a secret from the Retailer 1-2 and Manufacturer 1-1. The generated Redemption Encrypted Identifier 7-1 is downloaded to the Mobile Device corresponding to the Encrypted Consumer identifier 12-3. This “Download to Mobile Device” 10-3 may be accomplished in different ways. A preferred way to download the Redemption Encrypted Identifier to the Mobile Device is having the Mobile Device 5-1 or Mobile Device 5-1a downloading the Redemption Encrypted Identifier 7-1 directly to the Mobile Application 5-2 or Web Browser 5-17 by directly accessing the Electronic Clearing House Server 9-7 and providing the corresponding Encrypted Consumer identifier 12-3 in order to identify the corresponding Redemption Encrypted Identifier 7-1. A less preferable but possible way to download the Redemption Encrypted Identifier to the Mobile Device is for the Electronic Clearing House Server 9-7 to send the generated Redemption Encrypted Identifier to the Retailer Server 9-1 and included in the corresponding instance of the Electronic Coupon destined to the Mobile Device. Once the Redemption Encrypted Identifier 7-1 is downloaded to the Mobile Device, a corresponding Bar Code 6-8 representing the Redemption Encrypted Identifier is generated.

Finally, it is understood that the above descriptions are only illustrative of the principle of the current invention. Various alterations, improvements, and modifications will occur and are intended to be suggested hereby, and are within the spirit and scope of the invention. This invention can, however, be embodied in many different forms and should not be construed as limited to the embodiments set forth herein. Rather, these embodiments are provided so that the disclosure will be thorough and complete, and will fully convey the scope of the invention to those skilled in the arts. It is understood that the various embodiments of the invention, although different, are not mutually exclusive. In accordance with these principles, those skilled in the art can devise numerous modifications without departing from the spirit and scope of the invention.

What is claimed is:

1. An apparatus to redeem an electronic coupon comprising:
a Mobile Device coupled to an operating system;
the Mobile Device identifier identifies the Mobile Device in a plurality of Mobile Devices;
a coupon identifier which identifies the electronic coupon in a plurality of electronic coupons;
an electronic redemption process redeems the electronic coupon of a scanned bar code; and
a coupon instance identifier identifies a single digital instance of the electronic coupon in an encrypted way that is not known by the electronic redemption process.

2. The apparatus of claim 1, further comprising:
a mobile application displays the single digital instance of the electronic coupon on the Mobile Device.

3. The apparatus of claim 2, wherein
a discount is provided to a consumer presenting the electronic coupon on the mobile device.

4. The apparatus of claim 1, further comprising:
an electronic coupon clearing process of the electronic coupon performed by an Electronic Clearing House.

5. The apparatus of claim 4, further comprising:
at least one redemption parameter, a time of day and a date associated with the electronic coupon provided to the electronic coupon clearing process.

6. The apparatus of claim 4, further comprising:
a Manufacturer receives legitimately counted redeemed electronic coupons from the Electronic Clearing House.

7. The apparatus of claim 6, wherein
the Manufacturer reimburses a face value of the legitimately counted redeemed electronic coupons to a Retailer.

8. An apparatus for an electronic coupon comprising:
a Mobile Device coupled to an operating system displays a digital instance of the electronic coupon;
a bar code included in the digital instance of the electronic coupon presented to a Retailer;
a bar code scanner of the Retailer scans the bar code; and
an redemption identifier decryption function redeems a redemption encrypted identifier representing the electronic coupon of the scanned bar code.

9. The apparatus of claim 8, further comprising:
at least one redemption parameter, a time of day and a date associated with the electronic coupon provided to the electronic redemption identifier decryption function.

10. The apparatus of claim 9, further comprising:
a coupon instance identifier and a consumer identifier generated by the redemption identifier decryption function.

11. The apparatus of claim 10, wherein
if the coupon instance identifier and the consumer identifier matches one of the redemption parameters then the redemption encrypted identifier representing the electronic coupon corresponds to a legitimate redemption of the electronic coupon.

12. The apparatus of claim 11, further comprising:
a Manufacturer receives the legitimately redeemed electronic coupons to determine a final count.

13. The apparatus of claim 12, wherein
the Manufacturer reimburses a face value of the legitimately counted redeemed electronic coupons to the Retailer.

14. The apparatus of claim 8, further comprising:
a mobile application displays the digital instance of the electronic coupon on the Mobile Device.

15. An apparatus for a Multi-Key Identifier Encryption Function comprising:
a Mobile Device coupled to an operating system displays a digital instance of an electronic coupon;
a bar code scanner scans a bar code in the digital instance of the electronic coupon;
a first plurality of identifiers provided by the bar code scanner;
an identifier encryption function uses a first encryption key to compute an encrypted identifier; and
a first decryption key used by an identifier decryption function to compute a plurality of first decrypted identifiers from the encrypted identifier matching the first plurality of identifiers in the bar code.

16. The apparatus of claim 15, further comprising:
the first plurality of identifiers having a Mobile Device identifier, a consumer identifier, a coupon instance identifier and a redemption identifier; and
a second plurality of identifiers having the Mobile Device identifier, the consumer identifier, the coupon instance identifier and the redemption identifier provided by the bar code scanner.

17. The apparatus of claim 16, further comprising:
a second encryption key used by the identifier encryption function to compute the encrypted identifier.

18. The apparatus of claim 17, further comprising:
a second decryption key used by the identifier decryption function to compute a second plurality of decrypted identifiers from the encrypted identifier matching the second plurality of identifiers in the bar code.

19. The apparatus of claim 15, further comprising:
a time of day, a date, and a plurality of first parameters presented to the first encryption key; and
the time of day, the date, and a plurality of second parameters presented to the second encryption key.

20. The apparatus of claim 19, further comprising:
the first decryption key used by the identifier decryption function to compute a plurality of first decrypted parameters, the time of day, and the date from the encrypted identifier matching the first plurality of first parameters in the bar code, the time of day, and the date the electronic coupon was encrypted; and
the second decryption key used by the identifier decryption function to compute a plurality of second decrypted parameters, the time of day, and the date from the encrypted identifier matching the second plurality of second parameters in the bar code, the time of day, and the date the electronic coupon was encrypted.
